(19) United States
(12) Patent Application Publication
(10) Pub. No.: US 2026/0177875 A1
(43) Pub. Date: Jun. 25, 2026

(54) SEMICONDUCTOR DEVICE AND METHOD OF MANUFACTURING THE SAME

(71) Applicant: Taiwan Semiconductor Manufacturing Company, Ltd., Hsinchu (TW)

(72) Inventors: Tzu Jung TIEN, Hsinchu County (TW); Ming Yang JUNG, Kaohsiung City (TW)

(73) Assignee: Taiwan Semiconductor Manufacturing Company, Ltd., Hsinchu (TW)

(21) Appl. No.: 19/295,587

(22) Filed: Aug. 9, 2025

Related U.S. Application Data
(60) Provisional application No. 63/736,658, filed on Dec. 20, 2024.

(51) Int. Cl. G02F 1/225; G02F 1/01; G02F 1/21

(52) U.S. Cl. CPC G02F 1/2257; G02F 1/212; G02F 1/0102

(57) ABSTRACT

The present disclosure describes a semiconductor coupling device having a transmission line structure with a tunable microwave index. The semiconductor coupling device includes an optical waveguide on a substrate and a transmission line structure on the substrate and adjacent to the optical waveguide. The transmission line structure includes a first grille structure and a second grille structure. The semiconductor coupling device further includes an interconnect structure connected to the transmission line structure. The interconnect structures couples the transmission line structure to the optical waveguide and includes a transistor configured to electrically connect the first grille structure to the second grille structure

### CROSS-REFERENCE TO RELATED APPLICATION

This application claims the benefit of U.S. Provisional Patent Application No. 63/736,658, titled “Coupling Device,” filed Dec. 20, 2024, the disclosure of which is incorporated by reference in its entirety.

### BACKGROUND

The application of semiconductor photonics has revolutionized high-speed data communication systems, enabling the transmission of data over long distances via optical waveguides with low power consumption. Data in the form of optical signals can be modulated by electrical signals with optical modulators, which are key components in semiconductor photonics and can be formed with optical waveguides. The advances in semiconductor photonics have increased the complexity of semiconductor manufacturing processes.

### BRIEF DESCRIPTION OF THE DRAWINGS

Aspects of the present disclosure are best understood from the following detailed description when read with the accompanying figures.

FIG. 1A illustrates a top-down view of a semiconductor coupling device having a transmission line structure with a tunable microwave index, in accordance with some embodiments.

FIG. 1B illustrates a top-down view of an electrical portion of a semiconductor coupling device having a transmission line structure with a tunable microwave index, in accordance with some embodiments.

FIG. 1C illustrates a top-down view of an optical portion of a semiconductor coupling device having a transmission line structure with a tunable microwave index, in accordance with some embodiments.

FIG. 2 illustrates a schematic diagram of an optical modulator, in accordance with some embodiments.

FIGS. 3-6 illustrate electrical and optical signals of a semiconductor coupling device having a transmission line structure with a tunable microwave index, in accordance with some embodiments.

FIG. 7 illustrates an electro-optic spectrum as a function of frequency for a semiconductor coupling device having a transmission line structure with a tunable microwave index, in accordance with some embodiments.

FIG. 8 illustrates variations of an electro-optic bandwidth due to velocity mismatches between optical and electrical signals, in accordance with some embodiments.

FIGS. 9-20 illustrate partial top-down and cross-sectional views of a semiconductor coupling device having a transmission line structure with a tunable microwave index, in accordance with some embodiments.

FIGS. 21-24 illustrate pitch adjustment of a semiconductor coupling device having a transmission line structure for various microwave indexes, in accordance with some embodiments.

FIGS. 25-32 illustrate partial cross-sectional and isometric views of one or more transistors in a semiconductor coupling device having a transmission line structure with a tunable microwave index, in accordance with some embodiments.

FIGS. 33-36 illustrate partial top-down and cross-sectional views of a semiconductor coupling device having a metal heater for velocity match between optical and electrical signals, in accordance with some embodiments.

FIG. 37 is a flow diagram of a method for fabricating a semiconductor coupling device having a transmission line structure with a tunable microwave index, in accordance with some embodiments.

FIGS. 38-46 illustrate partial cross-sectional views of a semiconductor coupling device having a transmission line structure with a tunable microwave index at various stages of its fabrication process, in accordance with some embodiments.

FIG. 47 is a flow diagram of a method for modulating an optical signal with an adjusted electrical signal, in accordance with some embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. As used herein, the formation of a first feature on a second feature means the first feature is formed in direct contact with the second feature. In addition, the present disclosure may repeat reference numerals and/or letters in the various examples. This repetition does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It is noted that references in the specification to “one embodiment,” “an embodiment,” “an example embodiment,” “exemplary,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 20% of the value (e.g., ±1%, ±2%, ±3%, ±4%, ±5%, ±10%, ±20% of the value). These values are merely examples and are not intended to be limiting. The terms “about” and “substantially” can refer to a percentage of the values as interpreted by those skilled in relevant art(s) in light of the teachings herein.

In semiconductor photonics devices and photonic integrated circuit (PIC), optical modulators are components used for modulating optical signals propagating in optical waveguides. An optical modulator disposed in a section of an optical waveguide can include a P-N junction controlled by an external bias voltage. Under different bias conditions (e.g., forward bias or reverse bias) determined by the external bias voltage, the P-N junction can adjust a charge carrier density, hence an optical parameter (e.g., a refractive index) of the optical modulator such that an optical signal propagating in the optical waveguide can be modulated. The external bias voltage can include a direct-current (DC) bias voltage to control the operating point of the optical modulators for performance optimization. The external bias voltage can also include an electrical radio-frequency (RF) signal applied on a transmission line structure adjacent to the optical waveguides to modulate the optical signal with a dynamic phase shift. However, the process variations and input optical signal distortion and interference can increase the difficulty of the coupling between the electrical signal and the optical signal. Additionally, the group velocity of the optical signal in the optical waveguides can change with wavelengths, waveguide materials and dimensions, and temperatures, while the velocity of the electrical signal in the transmission line structure may not change with a fixed microwave index. The mismatch between the velocities of the electrical and optical signals can reduce the coupling between the electrical signal and the optical signal, reduce impedance matching of the optical modulator, increase the transmission loss of the transmission line structure, and reduce the signal-to-noise ratio and the bandwidth of the optical modulator.

Various embodiments in the present disclosure provide a semiconductor coupling device having a transmission line structure with a tunable microwave index. In some embodiments, the semiconductor coupling device can include an optical waveguide on a substrate and a transmission line structure on the substrate and adjacent to the optical waveguide. The optical waveguide can be configured to transmit an optical signal and the transmission line structure can be configured to transmit an electrical signal. The transmission line structure can include a first grille structure and a second grille structure. The semiconductor coupling device can further include an interconnect structure connected to the transmission line structure. The interconnect structure can couple the transmission line structure to the optical waveguide. The interconnect structure can include a transistor configured to electrically connect the first grille structure to the second grille structure. In some embodiments, by electrically connecting the first and second grille structures with the transistor, the pitch of the transmission line structure can be adjusted. As a result, the microwave index of the transmission line structure can be tuned to adjust the velocity of the electrical signal in the transmission line structure. With tunable microwave index of the transmission line structure, the velocity of the electrical signal can be matched to the velocity of the optical signal. Velocity match of the electrical and optical signals can improve the coupling between the electrical signal and the optical signal, improve impedance matching of the semiconductor coupling device, reduce the transmission loss of the transmission line structure, and increase the signal-to-noise ratio and the bandwidth of the semiconductor coupling device.

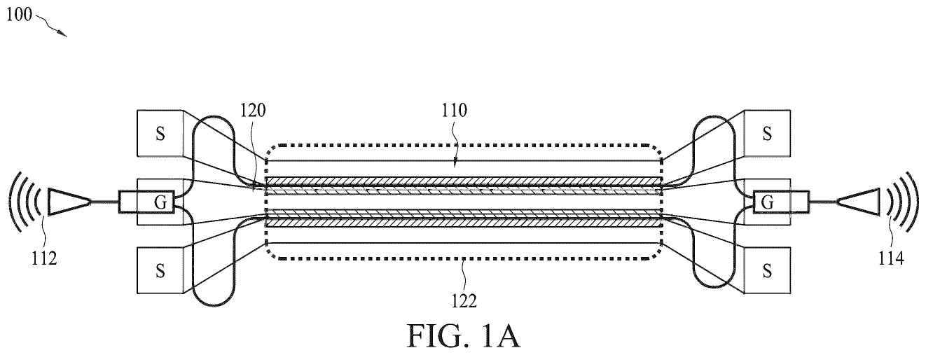

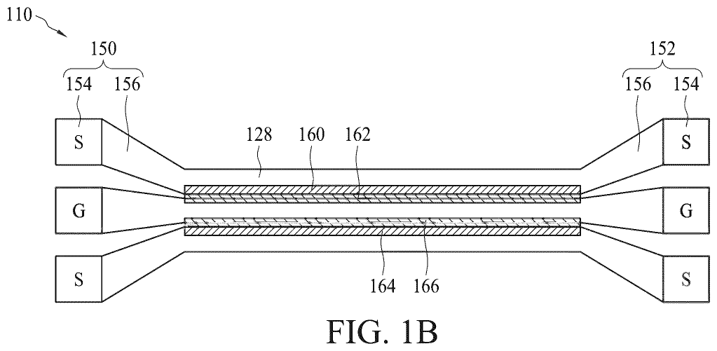

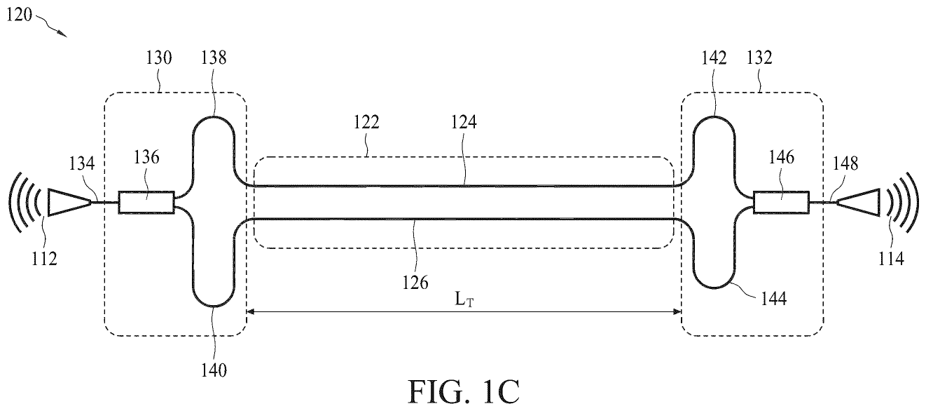

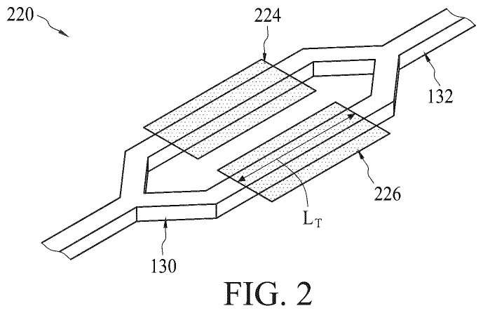

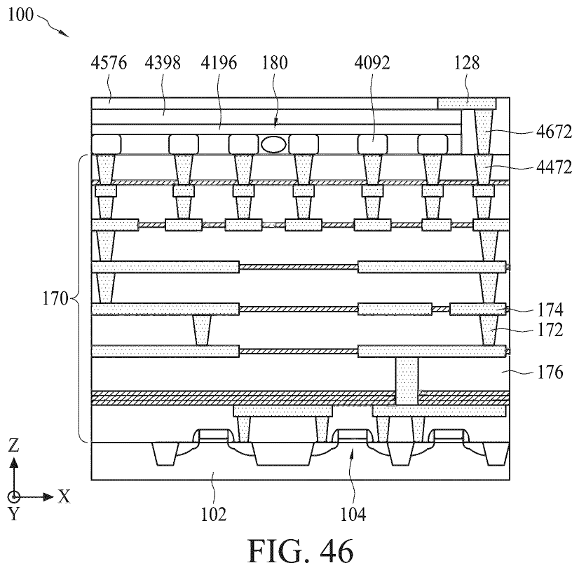

FIG. 1A illustrates a top-down view of a semiconductor coupling device 100 having a transmission line structure with a tunable microwave index, in accordance with some embodiments. In some embodiments, semiconductor coupling device 100 can include an electrical portion 110 and an optical portion 120. FIG. 1B illustrates a top-down view of electrical portion 110 of semiconductor coupling device 100, in accordance with some embodiments. FIG. 1C illustrates a top-down view of optical portion 120 of semiconductor coupling device 100, in accordance with some embodiments. FIG. 2 illustrates a schematic diagram of an optical modulator 220, in accordance with some embodiments. The discussion of elements of semiconductor coupling device 100 in FIGS. 1A-1C, 2-36, and 38-46 with the same annotations applies to each other, unless mentioned otherwise. And like reference numerals generally indicate identical, functionally similar, and/or structurally similar elements.

In some embodiments, optical modulator 220 can include a Mach-Zehnder modulator. Optical modulator 220 can use an optical splitter 130 to split light into first and second optical paths 224 and 226 of a dual-path phase modulator with electro-optically tunable optical path length difference, followed by an optical combiner 132. Optical modulator 220 can provide electro-optic modulation of the light output from optical combiner 132 due to constructive or destructive interference of the light in the two optical paths 224 and 226 depending on an electro-optically tuned optical path length difference. A phase difference of the light in the two paths of π radians (or an odd multiple thereof, e.g. 3π radians, 5π radians, et cetera) can produce destructive optical interference so that the light output intensity can be minimum or zero, while the in-phase condition (e.g., phase difference of 0 radians or 2π radians or 4π radians, etc.) can produce constructive optical interference so that the light output intensity can be maximum. Hence, optical modulator 220 can modulate light in an “on” versus “off” manner or in other modes.

In some embodiments, semiconductor coupling device 100 can include a traveling-wave Mach-Zehnder modulator (TWMZM). In some embodiments, a TWMZM can be a Mach-Zehnder modulator (e.g., optical modulator 220) in which the first and second optical paths are constructed as first and second optical waveguides. The electro-optic modulation can be implemented by way of an RF transmission line electrically coupled to the first and second optical waveguides. The phase difference of light in the two waveguides can be induced in a distributed fashion, over the length of the dual-path phase modulator. In the TWMZM, the material of the optical waveguides can be chosen to exhibit an electro-optic effect in which the refractive index of the material can change as a function of the applied electric field. The phase difference between the two paths can be modulated by the electro-optic effect in the dual-path phase modulator.

In some embodiments, as shown in FIGS. 1A-1C, electrical portion 110 of semiconductor coupling device 100 can be coupled to optical portion 120 to form optical modulator 122. In some embodiments, optical modulator 122 can modulate an input optical signal 112 and provide an output optical signal 114. In some embodiments, as shown in FIG. 1B, electrical portion 110 of semiconductor coupling device 100 can include electrical pads 150 and 152, transmission line structures 128, n-type strips 160 and 164, p-type strips 162 and 166. In some embodiments, as shown in FIG. 1C, optical portion 120 of semiconductor coupling device 100 can include an optical input port 134, an optical splitter 130, first optical waveguide 124, second optical waveguide 126, an optical combiner 132, and an optical output port 148. In some embodiments, optical modulator 220 can illustrate a schematic diagram of optical portion 120 of semiconductor coupling device 100.

In some embodiments, first and second optical waveguides 124 and 126 can form two optical paths of optical modulator 122. RF transmission line structures 128 can be electrically coupled to first and second optical waveguides 124 and 126. Transmission line structures 128 can be energized via electrical pads 150 and 152 to provide differential electro-optic phase modulation of the optical signals traveling through first and second optical waveguides 124 and 126. Electrical pads 150 and 152 can be electrically connected to transmission line structures 128 for applying an electrical signal (e.g., an RF modulation signal) to transmission line structures 128.

In some embodiments, as shown in FIG. 1B, electrical pads 150 and 152 can include contact pads 154 and tapered conductive structures 156. Contact pads 154 can be in contact with an electrical probe of a network analyzer or other electrical probes delivering electrical signals and ground potentials. Tapered conductive structures 156 can conduct the electrical signals and ground potentials to transmission line structures 128. In some embodiments, tapered conductive structures 156 can include tapered conductive traces of copper or other suitable metals. In some embodiments, top and bottom contact pads 154 can be connected to input electrical signals and can be denoted “S” in FIGS. 1A and 1B. In some embodiments, middle contact pads 154 can be connected to electrical ground potentials and can be denoted “G” in FIGS. 1A and 1B. In some embodiments, as shown in FIG. 1A, electrical pads 150 and optical splitter 130 can overlap laterally, and similarly electrical pads 152 and optical combiner 132 can overlap laterally. In some embodiments, the overlapping arrangements of electrical pads 150 and 152, optical splitter 130, and optical combiner 132 may be optional. In some embodiments, n-type strips 160 and 164 and p-type strips 162 and 166 can be connected to transmission line structures 128 and can couple the electrical signals and ground potentials to optical waveguides 124 and 126 to perform phase modulation of the light transmitting in optical waveguides 124 and 126.

In some embodiments, as shown in FIG. 1C, optical splitter 130 can optically couple input optical signal 112 to first ends of first and second optical waveguides 124 and 126. Optical combiner 132 can optically couple second ends of first and second optical waveguides 124 and 126 to output optical signal 114. In some embodiments, optical splitter 130 can include optical input port 134, a beam splitting element 136, and first and second optical arms 138 and 140. In some embodiments, beam splitting element 136 can split input optical signal 112 at optical input port 134 into first optical arm 138 and second optical arm 140. First optical arm 138 can feed input optical signal 112 into first optical waveguide 124 and second optical arm 140 can feed input optical signal 112 into second optical waveguide 126.

As shown in FIG. 1C, optical combiner 132 can include a first optical arm 142 connected to first optical waveguide 124 and a second optical arm 144 connected to second optical waveguide 126. First optical arm 142 can feed the optical signal output by first optical waveguide 124 into a beam combining element 146. Second optical arm 144 can feed the optical signal output by second optical waveguide 126 into beam combining element 146. The combined optical signal from beam combining element 146 can be output at an optical output port 148 as output optical signal 114. In some embodiments, optical splitter 130 and optical combiner 132 can include one-dimensional grating coupler (1DGC) elements. In some embodiments, beam splitting element 136 and beam combining element 146 can include multi-mode interferometer (MMI) optical power splitter/combiner elements.

In some embodiments, first and second optical waveguides 124 and 126 can have a length Lr based on the TWMZM design being developed, including factors such as the free-space wavelength of the light to be modulated, optical power of the light to be modulated, the refractive index (including electro-optical modulation thereof) of the material of first and second optical waveguides 124 and 126, space constraints imposed by the design, and so forth. In some embodiments, length LT can range from about 0.1 mm to about 3 mm. In some embodiments, the wavelength of the light to be modulated can be in the O-band (from about 1260 nm to about 1360 nm), the C-band (from about 1500 nm to about 1600 nm), or can be another wavelength in the infrared, visible, or ultraviolet wavelength ranges.

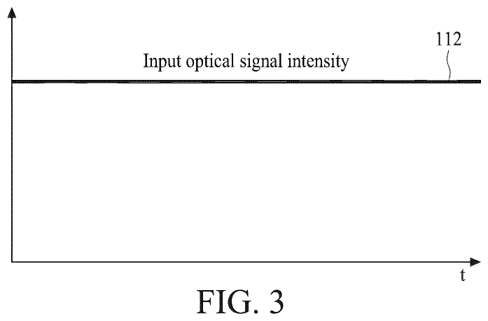

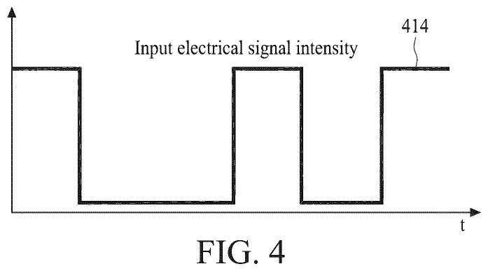

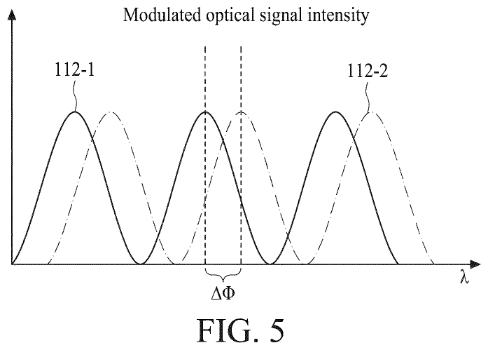

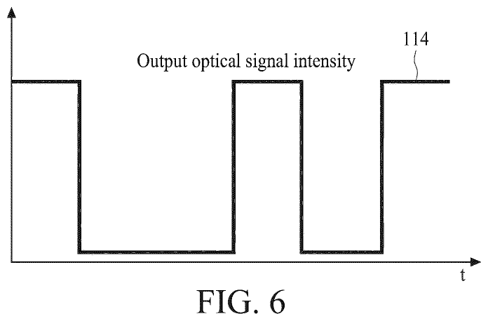

FIGS. 3-6 illustrate input and output electrical and optical signals of semiconductor coupling device 100, in accordance with some embodiments. In some embodiments, FIG. 3 can illustrate an intensity of input optical signal 112 versus time. In some embodiments, FIG. 4 can illustrate an intensity of input electrical signal 414 versus time. In some embodiments, FIG. 5 can illustrate intensities of modulated input optical signals 112-1 and 112-2 versus wavelength λ. As shown in FIG. 5, modulated input optical signals 112-1 and 112-2 can have a phase difference of ΔΦ. As described above, due to constructive or destructive interference of modulated input optical signals 112-1 and 112-2, intensities of output optical signal 114 can be modulated. In some embodiments, FIG. 6 can illustrate an intensity of output optical signal 114 versus time. As shown in FIGS. 3-6, the intensity of output optical signal 114 can be modulated by the intensity of input electrical signal 414. Though FIGS. 3-6 illustrate some example profiles for input optical signal 112, input electrical signal 414, and output optical signal 114, input and output electrical and optical signals of semiconductor coupling device 100 can have any suitable profiles.

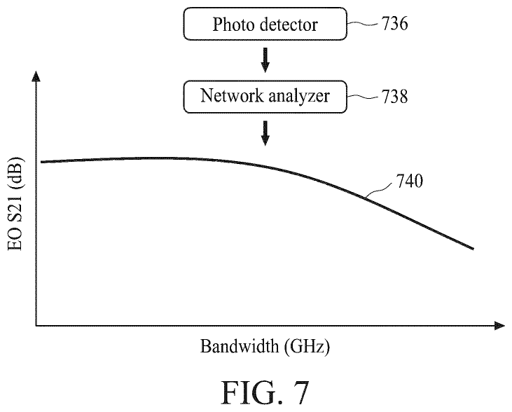

FIG. 7 illustrates an electro-optic spectrum 740 as a function of frequency for semiconductor coupling device 100, in accordance with some embodiments. In some embodiments, a photodetector 736 can be optically coupled to optical output port 148 of semiconductor coupling device 100 shown in FIGS. 1A-1C. In some embodiments, photodetector 736 can convert output optical signal 114 to a corresponding electrical signal. In some embodiments, the converted electrical signal can be input to a network analyzer 738. In some embodiments, network analyzer 738 can analyze the converted electrical signal and input electrical signal 414 to provide an electro-optic network parameter S21 (EO S21) for semiconductor coupling device 100. In some embodiments, network analyzer 738 can sweep the frequency of input electrical signal 414 to measure EO S21 of semiconductor coupling device 100 as a function of frequency, as shown by electro-optic spectrum 740 in FIG. 7.

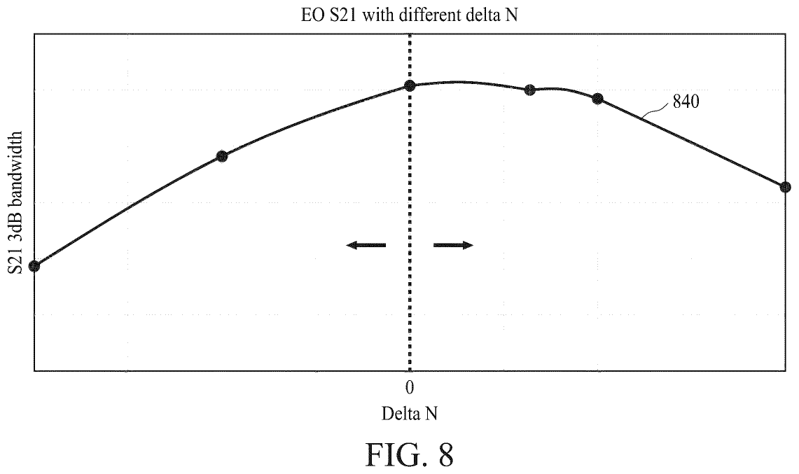

FIG. 8 illustrates variations of an electro-optic bandwidth of EO S21 for semiconductor coupling device 100 due to velocity mismatches between optical and electrical signals, in accordance with some embodiments. In some embodiments, a 3 dB bandwidth of EO S21 can be a modulation-speed characteristic of semiconductor coupling device 100. In some embodiments, the 3 dB bandwidth of EO S21 can be determined as the value of EO S21 that drops by 3 dB from its maximum value. In some embodiments, the maximum value of EO S21 can be determined at the lowest sweeping frequency of input electrical signal 414 in FIG. 7. In some embodiments, the 3 dB bandwidth of EO S21 can change due to the velocity mismatch between the optical signal and the electrical signal. For example, as shown in FIG. 8, delta N can represent a velocity difference between input optical signal 112 and input electrical signal 414. If the velocity of input optical signal 112 is greater than the velocity of input electrical signal 414, where delta N is greater than 0, the 3 dB bandwidth of EO S21 decreases as shown in FIG. 8. Similarly, if the velocity of input optical signal 112 is less than the velocity of input electrical signal 414, where delta N is less than 0, the 3 dB bandwidth of EO S21 decreases as shown in FIG. 8. As shown in FIG. 8, when delta N is about 0, the 3 dB bandwidth can reach a maximum value. Accordingly, when the velocity of input optical signal 112 matches with the velocity of input electrical signal 414, a maximum 3 dB bandwidth of EO S21 can be achieved.

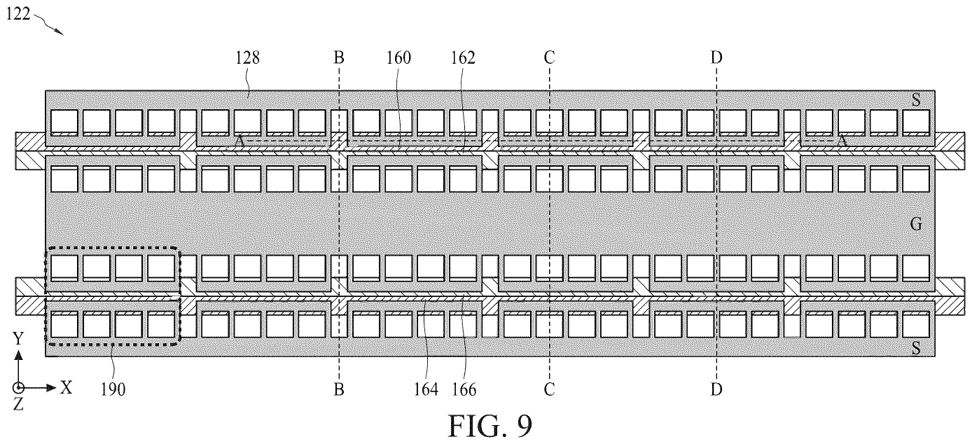

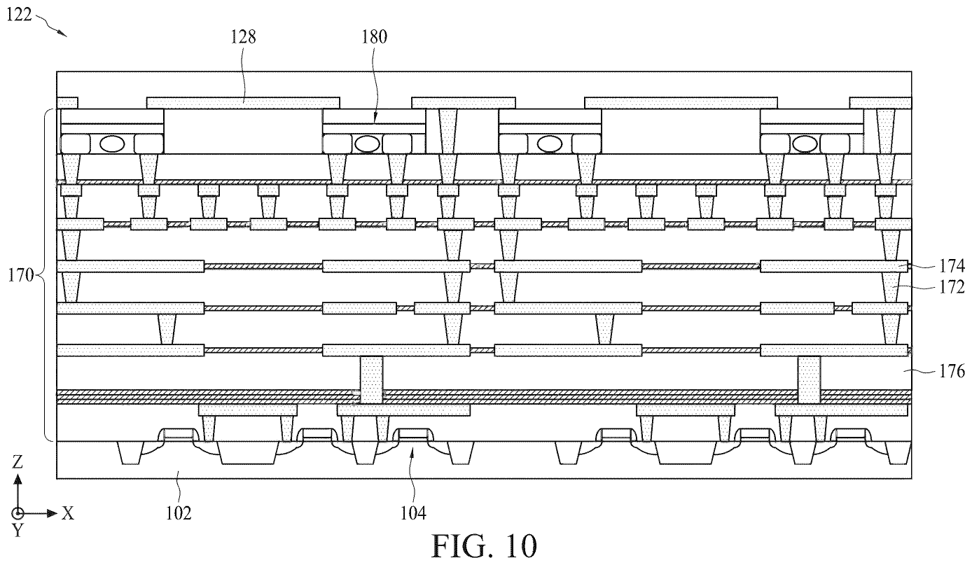

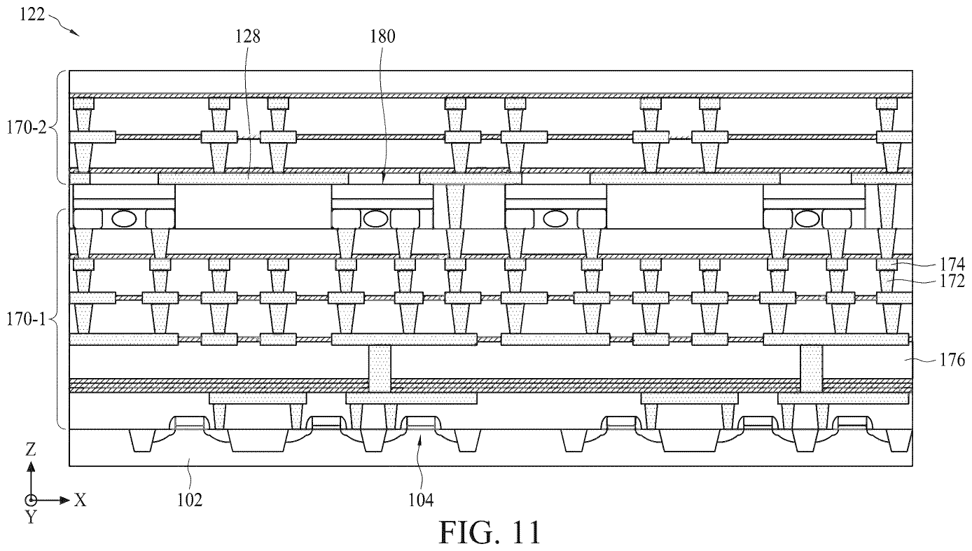

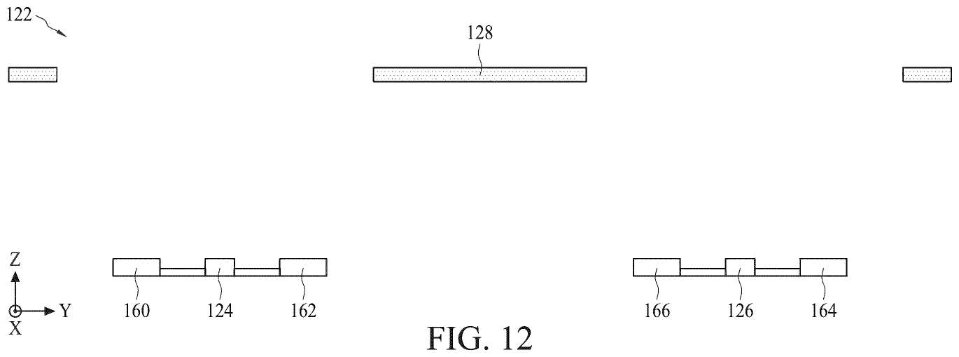

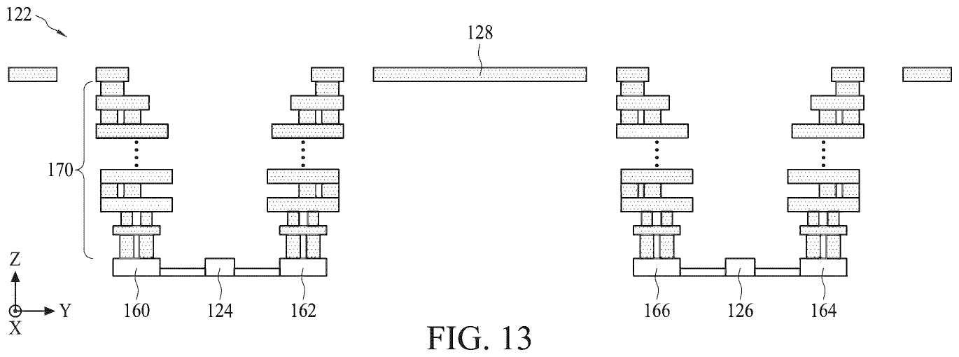

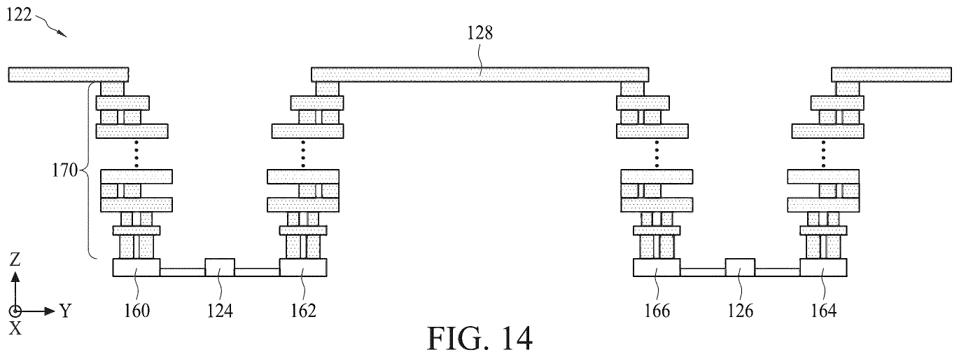

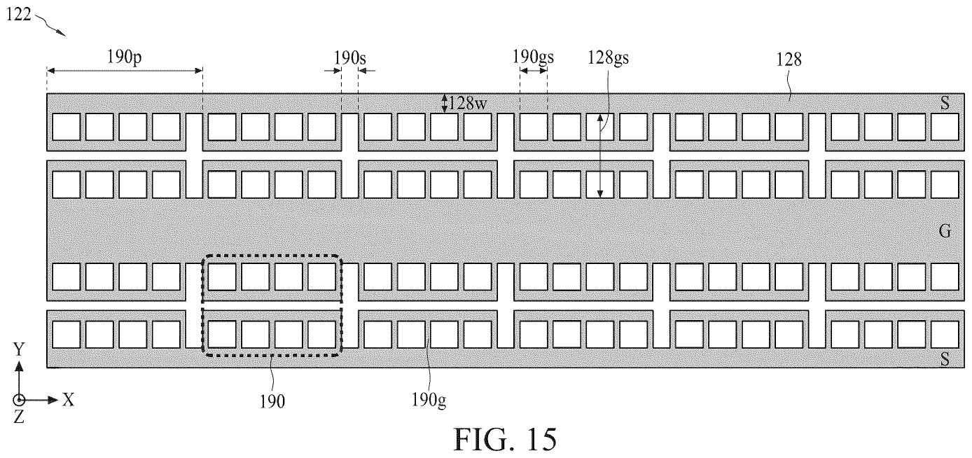

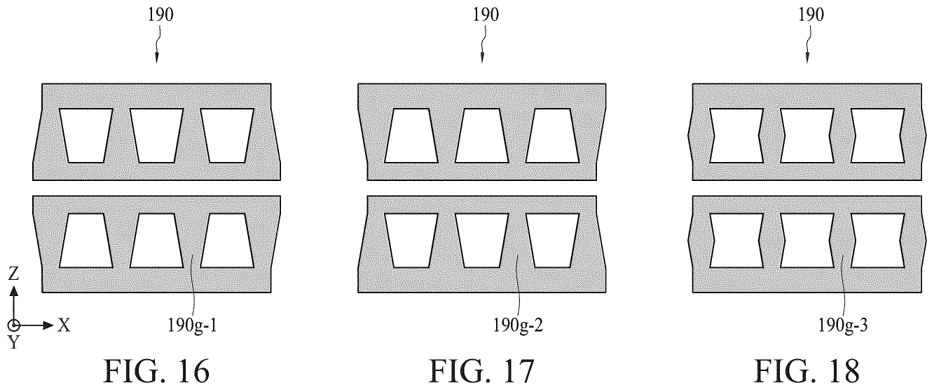

FIGS. 9-20 illustrate partial top-down and cross-sectional views of optical modulator 122 in semiconductor coupling device 100, in accordance with some embodiments. In some embodiments, FIG. 10 illustrates a cross-sectional view of optical modulator 122 along line A-A as shown in FIG. 9. In some embodiments, FIG. 11 illustrates a cross-sectional view of another embodiment of optical modulator 122 along line A-A as shown in FIG. 9. In some embodiments, FIG. 12 illustrates a cross-sectional view of optical modulator 122 along line B-B as shown in FIG. 9. FIG. 13 illustrates a cross-sectional view of optical modulator 122 along line C-C as shown in FIG. 9. FIG. 14 illustrates a cross-sectional view of optical modulator 122 along line D-D as shown in FIG. 9. In some embodiments, FIG. 15 illustrates various dimensions of optical modulator 122 in semiconductor coupling device 100. In some embodiments, FIGS. 16-20 illustrate various configurations of a grille structure in optical modulator 122 of semiconductor coupling device 100.

In some embodiments, as shown in FIGS. 9-14, optical modulator 122 of semiconductor coupling device 100 can be formed on substrate 102. In some embodiments, substrate 102 can include a semiconductor material, such as silicon. In some embodiments, substrate 102 includes a crystalline silicon substrate (e.g., wafer). In some embodiments, substrate 102 includes a silicon-on-insulator (SOI) substrate. In some embodiments, substrate 102 includes (i) an elementary semiconductor, such as germanium; (ii) a compound semiconductor including silicon carbide, gallium arsenide, gallium phosphide, indium phosphide, indium arsenide, and/or indium antimonide; (iii) an alloy semiconductor including silicon germanium carbide, silicon germanium, gallium arsenic phosphide, and/or aluminum gallium arsenide; or (iv) a combination thereof. Further, substrate 102 can be doped depending on design requirements (e.g., p-type substrate or n-type substrate). In some embodiments, substrate 102 can be doped with p-type dopants (e.g., boron, indium, aluminum, or gallium) or n-type dopants (e.g., phosphorus or arsenic). In some embodiments, multiple front-end-of-line transistors 104 can be formed on substrate 102 to connect and/or control semiconductor coupling device 100.

In some embodiments, as shown in FIG. 10, transmission line structures 128 can be a top metal layer on interconnect structures 170. In some embodiments, as shown in FIG. 11, transmission line structures 128 can be a metal layer between first interconnect structures 170-1 and second interconnect structures 170-2 (collectively referred to as “interconnect structures 170”). In some embodiments, interconnect structures 170 can include multiple metal layers and each metal layer can include metal vias 172 and metal lines 174 connected to each other. In some embodiments, metal vias 172 and metal lines 174 of interconnect structures 170 can be electrically connected to transmission line structures 128. In some embodiments, metal vias 172 and metal lines 174 can be configured to transmit electrical signals and ground potentials from transmission line structures 128 to n-type strips 160 and 164 and p-type strips 162 and 166 on substrate 102. In some embodiments, inter-metal dielectric layer (IDL) 176 can be disposed between the multiple metal layers of interconnect structures 170 to isolate adjacent metal vias 172 and metal lines 174. In some embodiments, metal vias 172 and metal lines 174 can include tungsten, cobalt, copper, copper alloy, or other suitable conductive materials. In some embodiments, IDL 176 can include silicon oxide or other suitable dielectric materials. Though eight layers of metal vias 172 and metal lines 174 are illustrated in FIGS. 10 and 11, interconnect structures 170 can include any layers of metal vias 172 and metal lines 174 and transmission line structures 128 can be disposed on any layers of metal vias 172 and metal lines 174.

In some embodiments, as shown in FIGS. 12-14, first optical waveguide 124 can be disposed adjacent to an n-p diode made of contacting n-type strip 160 and p-type strip 162. Similarly, second optical waveguide 126 can be disposed adjacent to an n-p diode made of contacting n-type strip 164 and p-type strip 166. In some embodiments, n-type strips 160 and 164 and p-type strips 162 and 166 can include a semiconductor material, such as silicon. In some embodiments, first and second optical waveguides 124 and 126 can be silicon waveguides and can include a silicon core and a silicon oxide cladding layer. In some embodiments, first and second optical waveguides 124 and 126 can include other suitable optical waveguides. In some embodiments, n-type strips 160 and 164 can be connected to a differential electrical signal. In some embodiments, p-type strips 162 and 166 can be connected to electrical ground potentials. In some embodiments, p-type strips 162 and 166 can be optionally merged to a single p-type strip as they are both grounded.

In some embodiments, n-type strip 160 and p-type strip 162 can couple the electrical signals in transmission line structures 128 to the optical signals in first optical waveguide 124. In some embodiments, the electric field generated at the n/p junction between n-type strip 160 and p-type strip 162 can change the refractive index of first optical waveguide 124 and cause electro-optical shift of the optical signals in first optical waveguide 124. Similarly, in some embodiments, n-type strip 164 and p-type strip 166 can couple the electrical signals in transmission line structures 128 to the optical signals in second optical waveguide 126. In some embodiments, the electric field generated at the n/p junction between n-type strip 164 and p-type strip 166 can change the refractive index of second optical waveguide 126 and cause electro-optical shift of the optical signals in second optical waveguide 126.

In some embodiments, as shown in FIGS. 9 and 15, transmission line structures 128 can include signal line structures (denoted “S”), a ground line structure (denoted “G”), and grille structures 190 with a pitch 190p. In some embodiments, signal line structures S can be connected to an electrical signal, such as an RF modulation signal, via metal pads 150 denoted “S.” In some embodiments, a voltage of the electrical signal can range from about 0 V to about 10 V. In some embodiments, Ground line structure G can be connected to a ground potential via metal pads 150 denoted “G.” In some embodiments, as shown in FIGS. 9 and 15, grille structures 190 can be disposed between ground line structure G and signal line structures S. In some embodiments, each grille structure 190 can include multiple grilles 190g as shown in FIG. 15. In some embodiments, grille structures 190 can be referred to as “grille electrodes 190.” In some embodiments, phase shift junction capacitance of transmission line structures 128 can be related to pitch 190p of grille structures 190. A larger pitch 190p can decrease the phase shift junction capacitance and a smaller pitch 190p can increase the phase shift junction capacitance. In some embodiments, the decrease of the phase shift junction capacitance can lead to a decrease of the microwave index of transmission line structures 128. In some embodiments, the decrease of the microwave index of transmission line structures 128 can lead to an increase of the velocity of the electrical signals in transmission line structures 128. Accordingly, a lager pitch 190p can decrease the microwave index and increase the velocity of the electrical signals in transmission line structures 128, and a smaller pitch 190p can increase the microwave index and decrease the velocity of the electrical signals in transmission line structures 128.

In some embodiments, as shown in FIG. 15, pitch 190p of grille structures 190 along an X-axis can range from about 5 μm to about 1000 μm. In some embodiments, as shown in FIG. 15, a spacing 190s along an X-axis between adjacent grille structures 190 can range from about 1 μm to about 20 μm. In some embodiments, a ratio between spacing 190s to pitch 190p can range from about 1% to about 50%. In some embodiments, as shown in FIG. 15, S strips of transmission line structures 128 can have a width 128w along a Y-axis ranging from about 0.01 μm to about 500 μm. In some embodiments, as shown in FIG. 15, a spacing 128gs along a Y-axis between signal and ground line structures of transmission line structures 128 can range from about 0.1 μm to about 500 μm. In some embodiments, as shown in FIG. 15, a spacing 190gs along an X-axis between adjacent grilles 190g can range from about 1 μm to about 5 μm. In some embodiments, each grille structure 190 can include a number N of grilles ranging from about 2 to about 100. In some embodiments, spacing 190gs between adjacent grilles 190g can be calculated by subtracting spacing 190s from pitch 190p and then divided by the number N. In some embodiments, the ranges of pitch 190p, spacing 190s, width 128w, spacing 128gs, and spacing 190gs described above can reduce the transmission loss of transmission line structures 128 and improve the velocity match between the electrical signals and the optical signals.

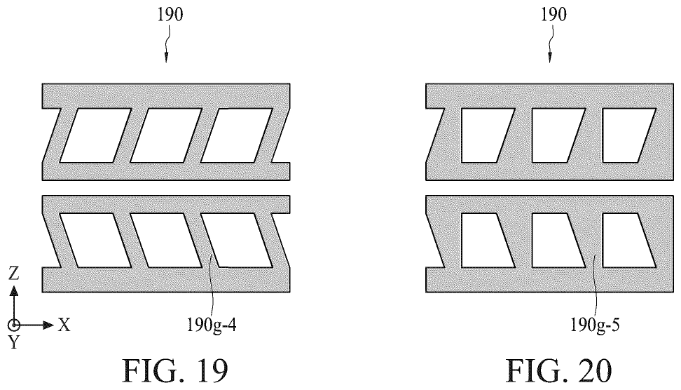

In some embodiments, as shown in FIG. 15, grille structures 190 can include straight grilles 190g forming multiple rectangles. In some embodiments, as shown in FIGS. 16-20, grille structures 190 can include various configurations of grilles 190g-1 to 190g-5. For example, as shown in FIG. 16, grilles 190g-1 can have a tapered shape tapering narrower from middle to edge. In some embodiments, as shown in FIG. 17, grilles 190g-2 can have a tapered shape tapering narrower from edge to center. In some embodiments, as shown in FIG. 18, grilles 190g-3 can have a spindle shape arranged vertically. In some embodiments, as shown in FIG. 19, grilles 190g-4 can be titled to form a diamond shape. In some embodiments, as shown in FIG. 20, grilles 190g-5 can have a shape of right triangle tapering narrower from center to edge. In some embodiments, grille structures 190 can have grilles 190g in other suitable configurations. In some embodiments, various configurations of grille structures 190 described above can be chosen to reduce the transmission loss and adjust the phase shift junction capacitance of transmission line structures 128.

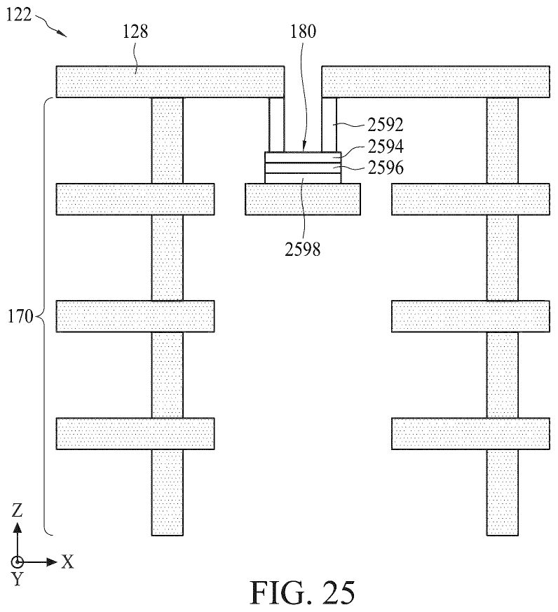

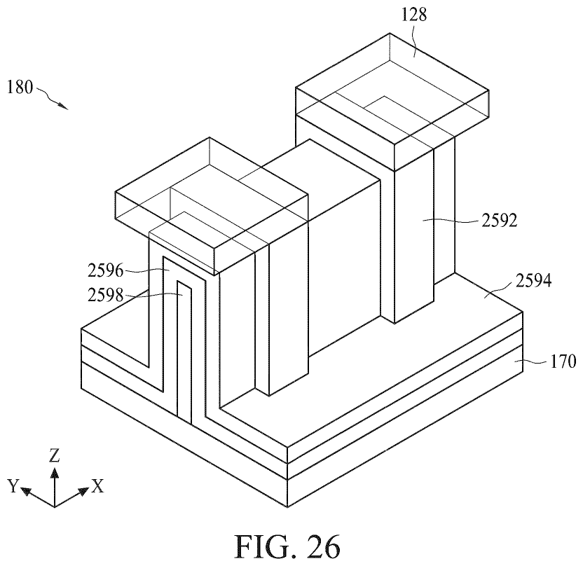

In some embodiments, as shown in FIGS. 9-11 and 21-24, one or more transistors 180 can be disposed between adjacent grille structures 190 and configured to electrically connect adjacent grille structures 190. In some embodiments, as shown in FIGS. 10 and 11, transistors 180 can be disposed between transmission line structures 128 and interconnect structures 170. In some embodiments, transistors 180 can be referred to as “back-end-of-line transistors 180” because transistors 180 can be disposed on or within interconnect structures 170. In some embodiments, gate terminals and source/drain (S/D) terminals of transistors 180 can be connected to different metal layers (described in detail below in FIGS. 25-32). In some embodiments, transistors 180 can be turned on to connect adjacent grille structures 190.

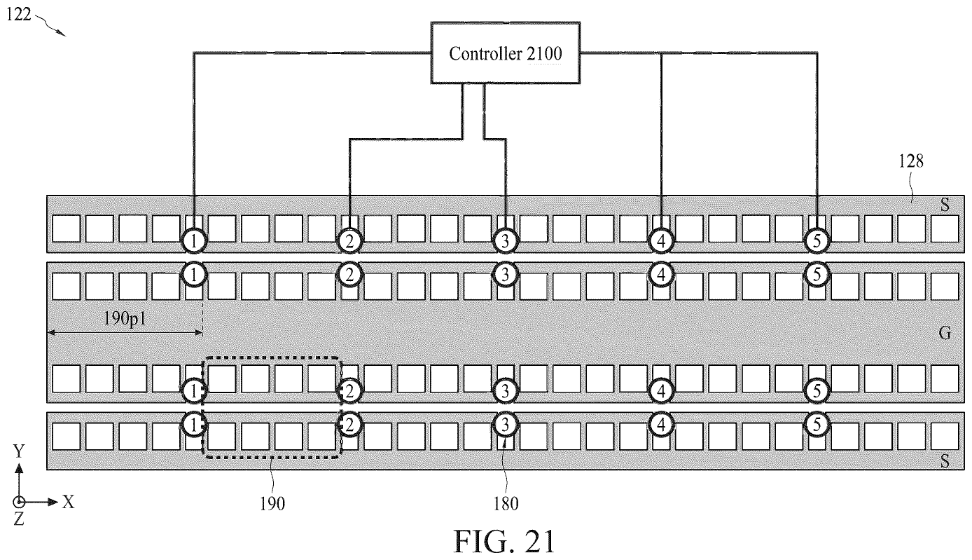

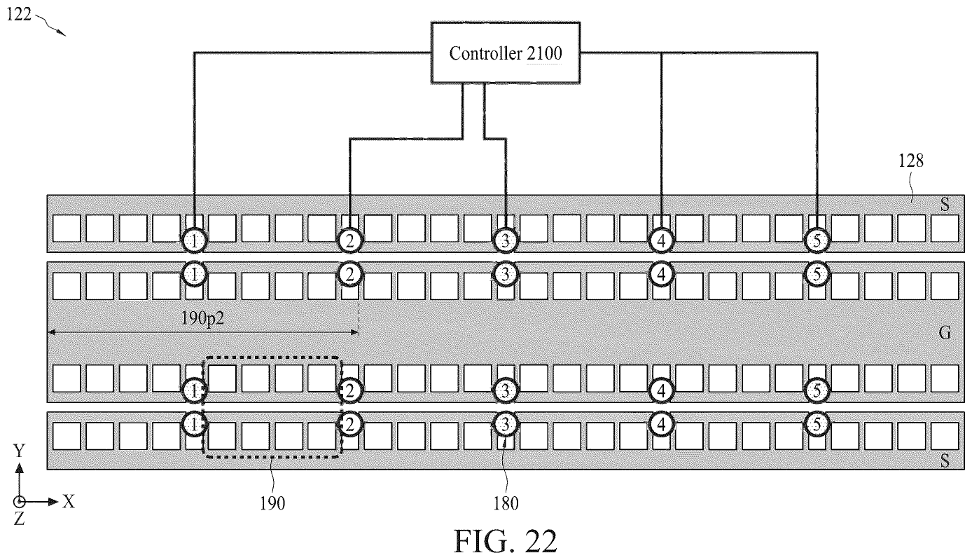

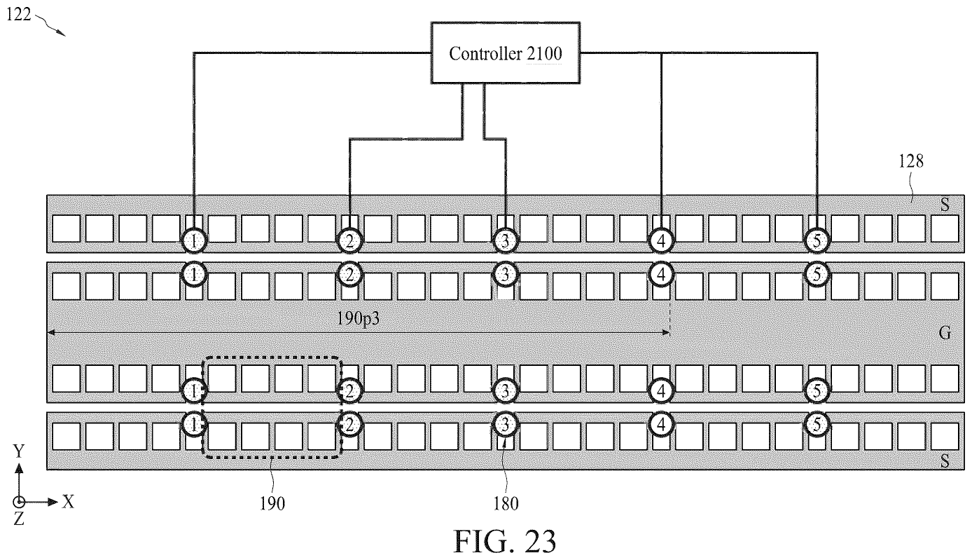

In some embodiments, as shown in FIGS. 21-24, controller 2100 can be configured to activate transistors 180 to electrically connect adjacent grille structures 190 and adjust pitch 190p of grille structures 190. Though FIGS. 21-24 illustrate transistors 180 at five positions 1-5, transistors 180 can be located at any positions between adjacent grille structures 190. In some embodiments, as shown in FIG. 21, when controller 2100 turns off transistors 180 at positions 1, 2, 3, 4, and 5, adjacent grille structures 190 may not be connected and grille structures 190 can have a pitch 190p1. In some embodiments, as shown in FIG. 22, when controller 2100 turns on transistors 180 at positions 1, 3, and 5 while turning off transistors 180 at positions 2 and 4, two adjacent grille structures 190 can be connected and grille structures 190 can have a pitch 190p2. In some embodiments, pitch 190p2 can be a summation (or combination) of two pitches 190p1 shown in FIG. 21. In some embodiments, as shown in FIG. 23, when controller 2100 turns on transistors 180 at positions 1, 2, 3, and 5 while turning off transistors 180 at position 4, four adjacent grille structures 190 can be connected and grille structures 190 can have a pitch 190p3. In some embodiments, pitch 190p3 can be a summation (or combination) of four pitches 190p1 shown in FIG. 21. With individual control of transistors 180 at positions 1-5, controller 2100 can tune pitch 190p of grille structures 190.

As a non-limiting illustrative example, grille structures 190 can have pitch 190p1 from about 40 μm to about 60 μm with no transistors 180 turned on. With transistors 180 turned on at positions 1, 3, and 5, grille structures 190 can have pitch 190p2 about 80 μm to about 120 μm. With transistors 180 turned on at positions 1, 2, 3, and 5, grille structures 190 can have pitch 190p3 about 180 μm to about 220 μm. In some embodiments, the phase shift junction capacitance of transmission line structures 128 can decrease with an increase of pitch 190p of grille structures 190, and the microwave index of transmission line structures 128 can decrease with a decrease of the phase shift junction capacitance. Accordingly, the microwave index can decrease with the increase of pitch 190p. For example, the microwave index can range from about 5.1 to about 5.4 for pitch 190p1, from about 4.8 to about 5.0 for pitch 190p2, and from about 4.75 to about 4.95 for pitch 190p3. The decrease of the microwave index can lead to an increase of the velocity of the electrical signals in transmission line structures 128.

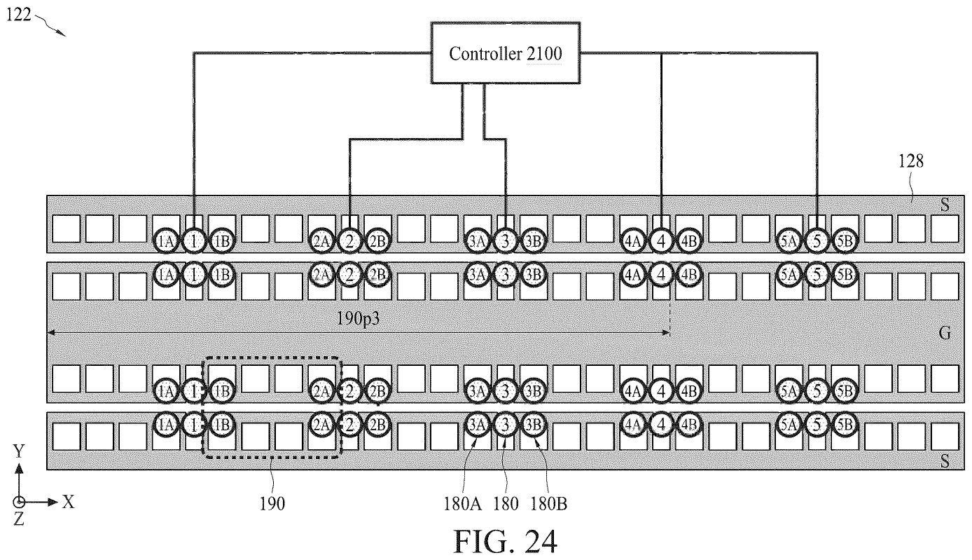

In some embodiments, optical modulator 122 can include one or more transistors 180 between adjacent grille structures 190. For example, as shown in FIG. 24, optical modulator 122 can include additional A-series and B-series transistors 180 at positions 1-5 between adjacent grille structures 190. In some embodiments, the A-series and B-series transistors 180 at positions 1-5 can fine tune the microwave index of transmission line structures 128. Though FIG. 24 illustrates three transistors 180 at each of positions 1-5 between adjacent grille structures 190, positions 1-5 between adjacent grille structures 190 can have any number of transistors 180. In some embodiments, as shown in FIG. 24, when controller 2100 turns on transistors 180 at positions 1A, 1, 1B, 2A, 2, 2B, 3A, 3, 3B, 5A, 5, and 5B while turning off transistors 180 at positions 4A, 4, and 4B, four adjacent grille structures 190 can be connected and grille structures 190 can have a pitch 190p3. In some embodiments, pitch 190p3 can be a summation (or combination) of four pitches 190p1 shown in FIG. 21. In some embodiments, the microwave index of transmission line structures 128 can be fine-tuned with individual control of transistors 180 at positions 4A, 4, and 4B. For example, with transistors 180 at positions 1A, 1, 1B, 2A, 2, 2B, 3A, 3, 3B, 5A, 5, and 5B turned on, controller 2100 can turn on transistors 180 at position 4A while turning off transistors 180 at positions 4 and 4B. Alternatively, controller 2100 can turn on transistors 180 at positions 4A and 4 while turning off transistors 180 at position 4B, or controller 2100 can turn on transistors 180 at positions 4A, 4, and 4B. With individual control of transistors 180 at positions 4A, 4, and 4B, the microwave index of transmission line structures 128 can be additionally fine-tuned by about 0.3 to about 0.5 around the microwave index at pitch 190p3.

Though FIGS. 21-24 illustrate 1, 2, and 4 adjacent grille structures 190 connected to transistors 180, any number of adjacent grille structures 190 can be connected to transistors 180 to tune the microwave index of transmission line structures 128. With tunable microwave index of transmission line structures 128, the velocity of the electrical signals in transmission line structures 128 can be matched to the velocity of the optical signals in optical waveguides 124 and 126. Velocity match of the electrical and optical signals can improve the coupling between the electrical signals and the optical signals, improve impedance matching of optical modulator 122, reduce the transmission loss of transmission line structures 128, and increase the signal-to-noise ratio and the S21 3 dB bandwidth of semiconductor coupling device 100.

FIGS. 25-32 illustrate partial cross-sectional and isometric views of one or more transistors 180 in semiconductor coupling device 100, in accordance with some embodiments. In some embodiments, as shown in FIG. 25, transistors 180 can include S/D terminals 2592, a channel structure 2594, a gate dielectric layer 2596, and a gate terminal 2598. In some embodiments, S/D terminals 2592 and gate terminal 2598 can include tungsten, tungsten silicide, titanium nitride, ruthenium, doped polysilicon, or other suitable conductive materials. In some embodiments, channel structure 2594 can include amorphous silicon, indium gallium zinc oxide, indium gallium oxide, gallium zinc oxide, indium zinc oxide, or other semiconductor materials. In some embodiments, channel structure 2594 can be doped with aluminum or other suitable dopants. In some embodiments, gate dielectric layer 2596 can include silicon oxide, silicon nitride, silicon oxynitride, hafnium oxide, zirconium oxide, or other suitable dielectric materials.

In some embodiments, as shown in FIG. 26, transistors 180 can include a three dimensional (3D) thin-film transistor (TFT). In some embodiments, the 3D TFT can connect adjacent grille structures 190 with a smaller on-state resistance. In some embodiments, as shown in FIG. 26, S/D terminals 2592 of transistors 180 can be in contact with transmission line structures 128. Gate terminal 2598 and gate dielectric layer 2596 of transistors 180 can be in contact with interconnect structures 170. In some embodiments, as shown in FIGS. 25 and 26, S/D terminals 2592 of transistors 180 can be connected to the top metal layer of transmission line structures 128. Gate terminal 2598 of transistors 180 can be connected to a metal layer of interconnect structures 170. Accordingly, S/D terminals 2592 and gate terminal 2598 of transistors 180 can be connected to different metal layers of interconnect structures 170.

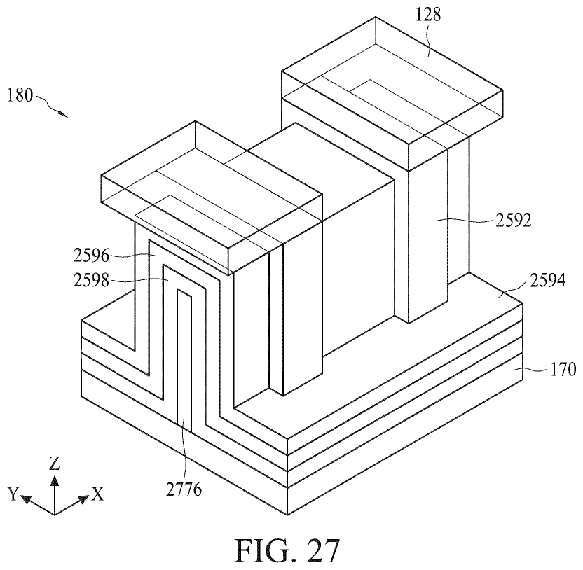

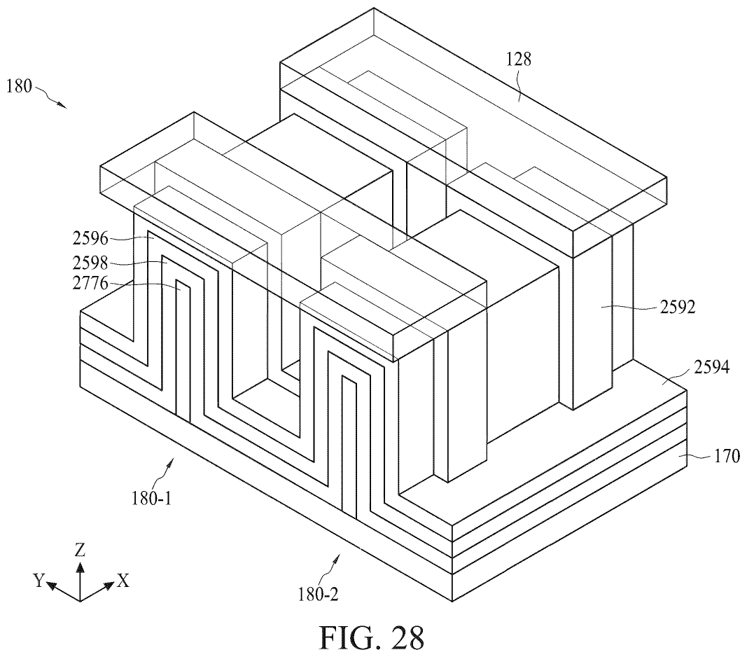

In some embodiments, as shown in FIG. 27, transistors 180 can include a 3D TFT with a wider channel structure 2594. In some embodiments, wider channel structure 2594 can further reduce the on-state resistance of transistors 180. In some embodiments, as shown in FIG. 27, with a wider channel structure 2594, gate terminal 2598 can surround a dielectric structure 2776. In some embodiments, dielectric structure 2776 can be disposed on interconnect structures 170 and can include silicon oxide or other suitable dielectric materials. In some embodiments, dielectric structure 2776 and IDL 176 can include a same dielectric material.

In some embodiments, as shown in FIG. 28, transistors 180 can include two transistors 180-1 and 180-2 in parallel to increase a width of channel structure 2594. In some embodiments, wider channel structure 2594 in parallel transistors 180-1 and 180-2 can further reduce the on-state resistance of transistors 180. In some embodiments, as shown in FIG. 28, gate terminal 2598 can surround dielectric structure 2776 in each of transistors 180-1 and 180-2. In some embodiments, as shown in FIG. 28, S/D terminals 2592 of transistors 180-1 and 180-2 can be connected to a same metal layer. Gate terminals 2598 of transistors 180-1 and 180-2 can be connected to a same metal layer.

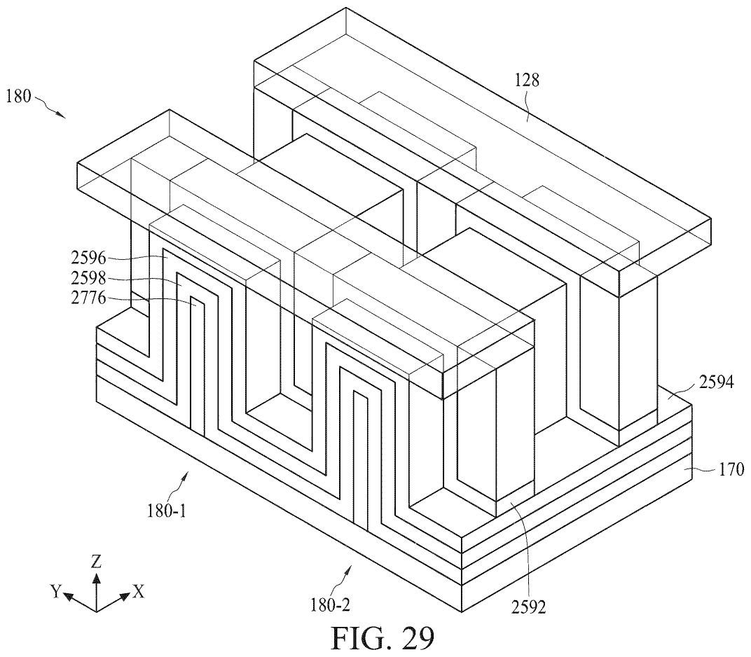

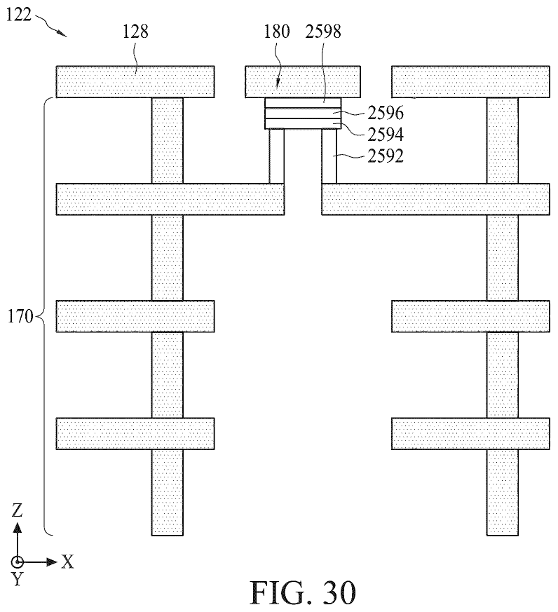

In some embodiments, as shown in FIG. 29, the contact area between transmission line structures 128 and S/D terminals 2592 of transistors 180-1 and 180-2 in parallel can be increased to further reduce the on-state resistance of transistors 180. In some embodiments, as shown in FIG. 29, top, bottom, and sidewall surfaces of S/D terminals 2592 can be connected to transmission line structures 128 to increase the contact area.

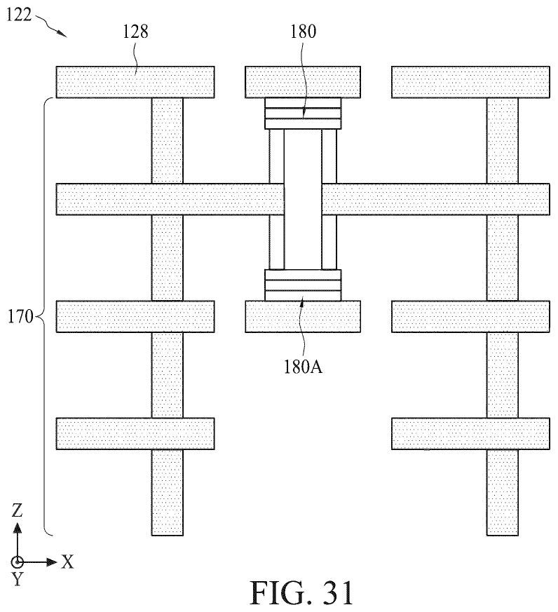

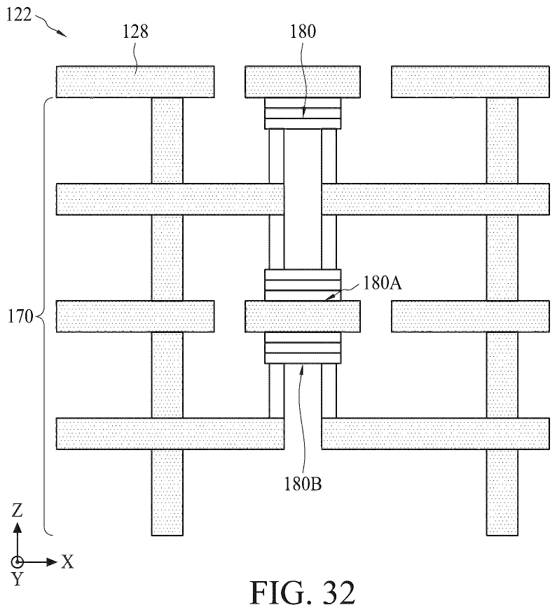

In some embodiments, as shown in FIG. 30, S/D terminals 2592 of transistors 180 can be connected to a metal layer of interconnect structures 170 and gate terminal 2598 can be connected to transmission line structures 128. As shown in FIG. 30, gate terminal 2598 and S/D terminals 2592 of transistors 180 can be connected to different metal layers. In some embodiments, as shown in FIG. 31, additional transistors 180A can be disposed in interconnect structures 170 and in parallel with transistors 180 to reduce transistor impedance. Transistors 180 and 180A can be connected to transmission line structures 128 and interconnect structures 170. As shown in FIG. 30, S/D terminals of transistors 180 and 180A can be connected to a same metal layer. Gate terminals of transistors 180 and 180A can be connected to different metal layers. In some embodiments, as shown in FIG. 32, additional transistors 180B can be disposed in interconnect structures 170 and in parallel with transistors 180 and 180A to further reduce transistor impedance. As shown in FIG. 32, S/D terminals of 180 and 180A can be connected to a same metal layer while S/D terminals of 180B can be connected to a different metal layer. Gate terminals of 180A and 180B can be connected to a same metal layer while gate terminal of 180 can be connected to a different metal layer. In some embodiments, FIGS. 31 and 32 can illustrate the connections of transistors 180 between adjacent grille structures 190 in FIG. 24.

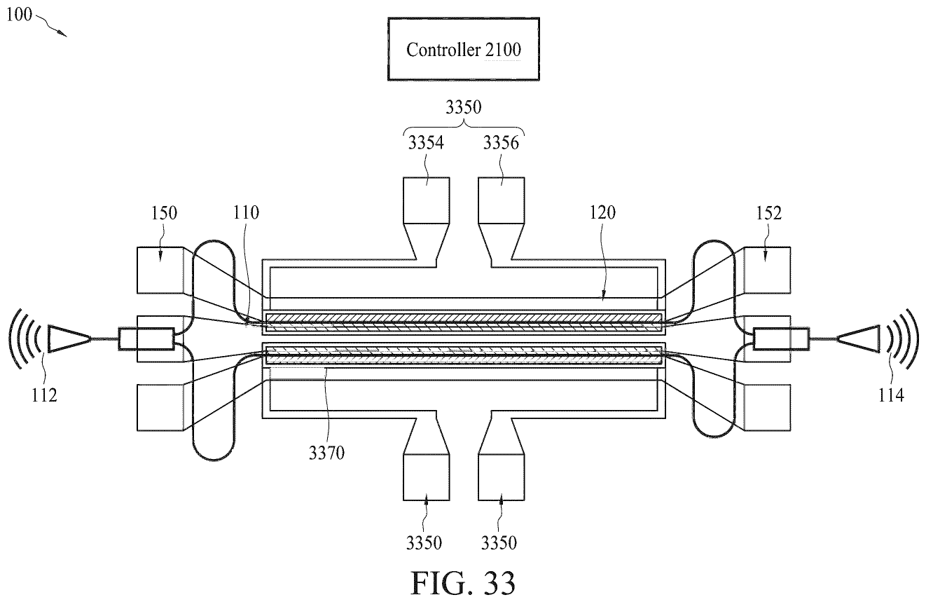

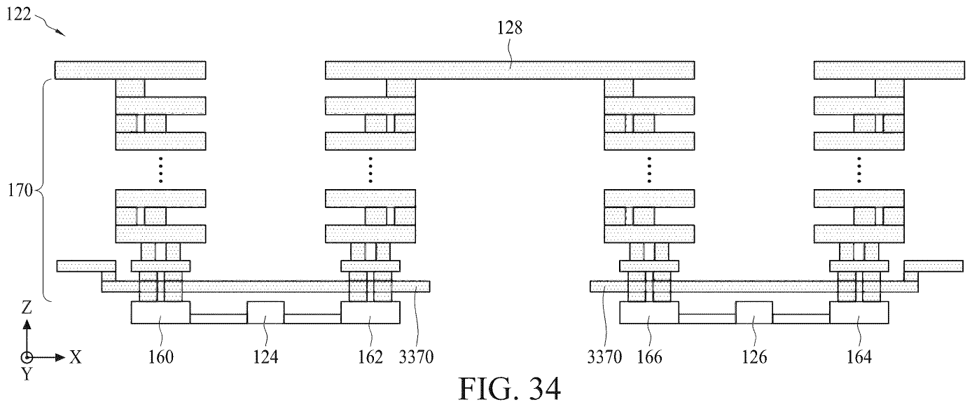

FIGS. 33-36 illustrate partial top-down and cross-sectional views of semiconductor coupling device 100 having a metal heater 3370, in accordance with some embodiments. In some embodiments, FIGS. 34-36 illustrate partial cross-sectional views of optical modulator 122 in semiconductor coupling device 100 along line D-D as shown in FIG. 9. In some embodiments, as shown in FIGS. 33-36, metal heater 3370 can be disposed adjacent to n-type strips 160 and 164, p-type strips 162 and 166, and first and second optical waveguides 124 and 126. In some embodiments, metal heater 3370 can be connected to electrical pads 3350 through interconnect structures 170. As shown in FIG. 33, electrical pads 3350 can include contact pads 3354 and tapered conductive structures 3356. In some embodiments, controller 2100 can control an electrical current in metal heater 3370 via electrical pads and interconnect structures 170 to generate heat and tune the temperature of materials and structures adjacent to meal heater 3370.

In some embodiments, as shown in FIGS. 33-36, metal heater 3370 can increase a temperature of first and second optical waveguides 124 and 126. In some embodiments, a temperature increase of first and second optical waveguides 124 and 126 can increase the refractive index of waveguides 124 and 126. The increase of the refractive index of waveguides 124 and 126 can decrease the velocity of the optical signals in optical waveguides 124 and 126. Accordingly, metal heater 3370 can tune the temperature of waveguides 124 and 126 and thus tune the velocity of the optical signals in optical waveguides 124 and 126. In some embodiments, controller 2100 can control metal heater 3370 to tune the temperature and match the velocity of the optical signals to the velocity of the electrical signals in semiconductor coupling device 100. Velocity match of the electrical and optical signals can improve the coupling between the electrical signals and the optical signals, improve impedance matching of optical modulator 122, reduce the transmission loss of transmission line structures 128, and increase the signal-to-noise ratio and the S21 3 dB bandwidth of semiconductor coupling device 100.

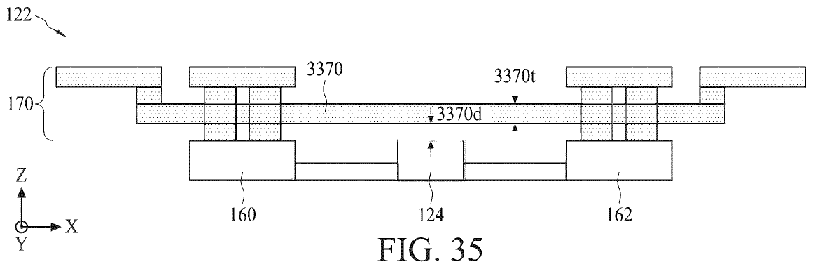

In some embodiments, as shown in FIGS. 34 and 35, metal heater 3370 can be disposed above first and second optical waveguides 124 and 126. In some embodiments, metal heater 3370 can have a thickness 3370t along a Z-axis ranging from about 0.1 μm to about 50 μm. If thickness 3370t is less than about 0.1 μm, metal heater 3370 may not effectively tune the temperature of waveguides 124 and 124. If thickness 3370t is greater than about 50 μm, manufacturing cost may increase. In some embodiments, a distance 3370d along a Z-axis between metal heater 3370 and waveguides 124 and 126 can range from about 0 μm to about 500 μm. If distance 3370d is less than about 0 μm, metal heater 3370 can be disposed on substrate 102 close to transistors 104. Transistors 104 and other devices on substrate 102 can be affected by metal heater 3370. If distance 3370d is greater than about 500 μm, metal heater 3370 may not effectively change the temperature of waveguides 124 and 124 and may not tune the velocity of the optical signals.

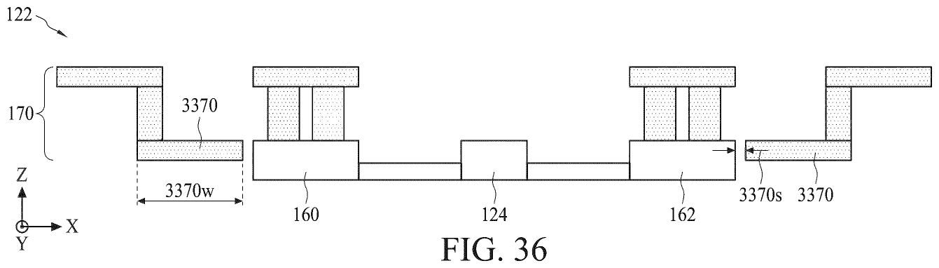

In some embodiments, as shown in FIG. 36, metal heater 3370 can be disposed on left and right sides of first optical waveguide 124. Though FIG. 36 illustrates metal heater 3370 around first optical waveguide 124, metal heater 3370 can be similarly disposed on left and right sides of second optical waveguide 126. In some embodiments, metal heater 3370 on left and right sides of waveguides 124 and 126 can have a width 3370w along an X-axis ranging from about 0.1 μm to about 1000 μm. If width 3370w is less than about 0.1 μm, metal heater 3370 may not effectively tune the temperature of waveguides 124 and 124. If width 3370w is greater than about 1000 μm, manufacturing cost may increase. In some embodiments, a spacing 3370s along an X-axis between metal heater 3370 and n-type strip 160 or p-type strip 162 can range from about 0 μm to about 500 μm. If spacing 3370s is less than about 0 μm, metal heater 3370 can be disposed on n-type strip 160 and p-type strip 162 and affect the performance of n-type strip 160 or p-type strip 162. If spacing 3370s is greater than about 500 μm, metal heater 3370 may not effectively change the temperature of waveguides 124 and 124 and may not tune the velocity of the optical signal.

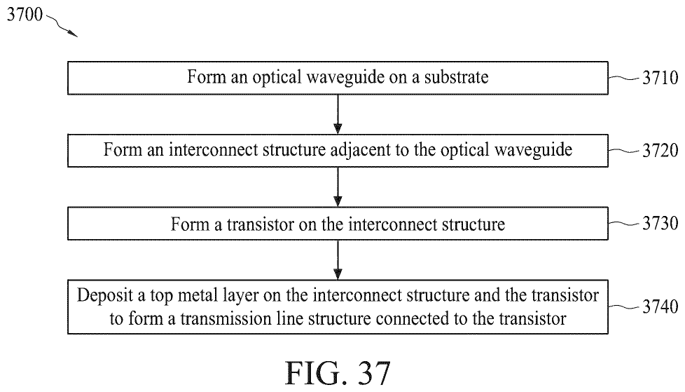

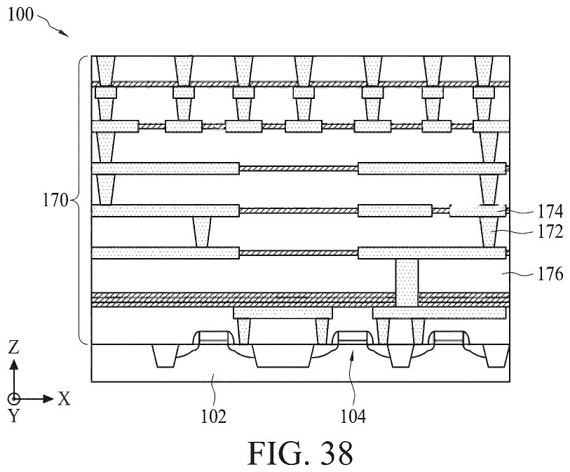

FIG. 37 is a flow diagram of a method 3700 for fabricating semiconductor coupling device 100 having a transmission line structure with a tunable microwave index, in accordance with some embodiments. Method 3700 may not be limited to semiconductor coupling device 100 and can be applicable to other coupling devices that would benefit from the tunable microwave index of the transmission line structure. Additional operations may be performed between various operations of method 3700 and may be omitted merely for clarity and ease of description. Additional operations can be provided before, during, and/or after method 3700; one or more of these additional operations are briefly described herein. Moreover, not all operations may be needed to perform the disclosure provided herein. Additionally, some of the operations may be performed simultaneously or in a different order than shown in FIG. 37. In some embodiments, one or more other operations may be performed in addition to or in place of the presently-described operations. For illustrative purposes, the operations illustrated in FIG. 37 will be described with reference to the example embodiments as illustrated in FIGS. 9-14 and 38-46. In some embodiments, FIGS. 38-46 illustrate partial cross-sectional views of optical modulator 122 in semiconductor coupling device 100 along line A-A as shown in FIG. 9.

In referring to FIG. 37, method 3700 begins with operation 3710 and the process of forming an optical waveguide on a substrate. For example, as shown in FIGS. 10-14, first and second optical waveguides 124 and 126 can be formed on substrate 102. In some embodiments, as shown in FIGS. 9-14 and 38, front-end-of-line transistors 104, n-type strips 160 and 164, and p-type strips 162 and 166 can be formed on substrate 102. In some embodiments, an electro-optic material can be deposited on substrate 102 to form first and second optical waveguides 124 and 126. First optical waveguides 124 can be formed adjacent to n-type strip 160 and p-type strip 162. Second optical waveguides 126 can be adjacent to n-type strip 164 and p-type strip 166. In some embodiments, first and second optical waveguides 124 and 126 can be silicon waveguides and can include a silicon core and a silicon oxide cladding layer.

Referring to FIG. 37, in operation 3720, an interconnected structure is formed adjacent to the optical waveguides. For example, as shown in FIGS. 9-14, interconnect structures 170 can be formed adjacent to first and second optical waveguides 124 and 126. In some embodiments, as shown in FIGS. 9-14 and 38, interconnect structures 170 can be formed above first and second optical waveguides 124 and 126, n-type strips 160 and 164, and p-type strips 162 and 166. In some embodiments, interconnect structures 170 can be connected to n-type strips 160 and 164 and p-type strips 162 and 166. In some embodiments, as shown in FIGS. 9-14 and 38, interconnect structures 170 can include multiple metal layers and each metal layer can include metal vias 172 and metal lines 174 connected to each other. In some embodiments, IDL 176 can be disposed between the multiple metal layers of interconnect structures 170 to isolate adjacent metal vias 172 and metal lines 174. After the formation of interconnect structures 170, a chemical-mechanical planarization (CMP) process can planarize top surfaces of interconnect structures 170 and IDL 176, as shown in FIG. 38.

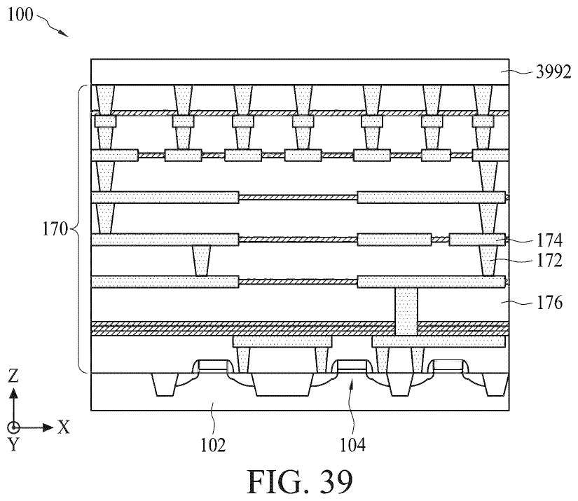

Referring to FIG. 37, in operation 3730, a transistor is formed on the interconnected structure. For example, as shown in FIGS. 9-14 and 39-45, transistors 180 can be formed on interconnect structures 170. In some embodiments, the formation of transistors 180 can include the formation of channel structures and S/D terminals, the formation of gate dielectric layer, and the formation of gate terminal. As shown in FIG. 39, a semiconductor layer 3992 can be deposited on interconnect structures 170. In some embodiments, semiconductor layer 3992 can be deposited by chemical vapor deposition (CVD), atomic layer deposition (ALD), physical vapor deposition (PVD), and other suitable deposition methods. In some embodiments, semiconductor layer 3992 can include amorphous silicon, indium gallium zinc oxide, indium gallium oxide, gallium zinc oxide, or indium zinc oxide, or other semiconductor materials. In some embodiments, semiconductor layer 3992 can form channel structures and S/D regions of transistors 180.

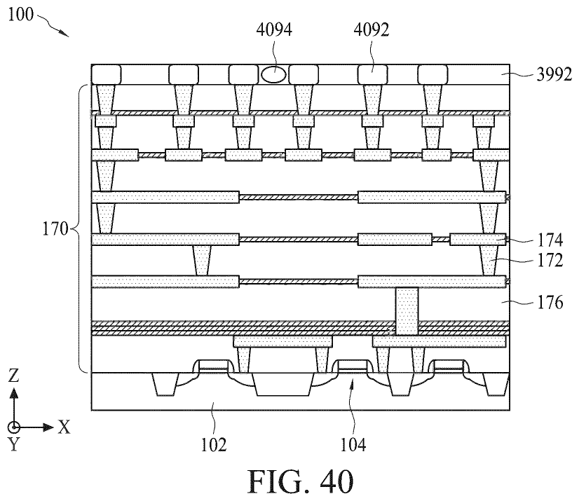

In some embodiments, as shown in FIG. 40, S/D regions 4092 and channel structures 4094 can be formed in semiconductor layer 3992. In some embodiments, S/D regions 4092 can be exposed through a patterning layer and can be implanted with dopants. In some embodiments, channel structures 4094 can be formed between S/D regions 4092 and can be implanted with dopants to tune the threshold voltage of transistors 180. In some embodiments, S/D regions 4092 can act as the S/D terminals of transistors 180.

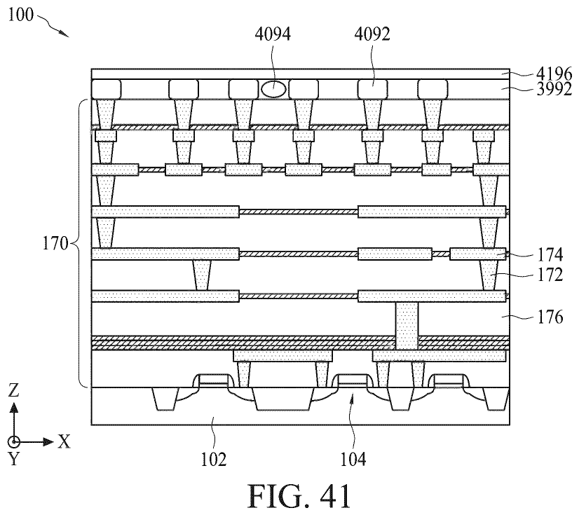

The formation of S/D regions 4092 and channel structures 4094 can be followed by the formation of gate dielectric layer. For example, as shown in FIG. 41, gate dielectric layer 4196 can be deposited on S/D regions 4092 and channel structures 4094. In some embodiments, gate dielectric layer 4196 can be conformally deposited on S/D regions 4092 and channel structures 4094. In some embodiments, gate dielectric layer 4196 can include silicon oxide, silicon nitride, silicon oxynitride, hafnium oxide, zirconium oxide, or other suitable dielectric materials.

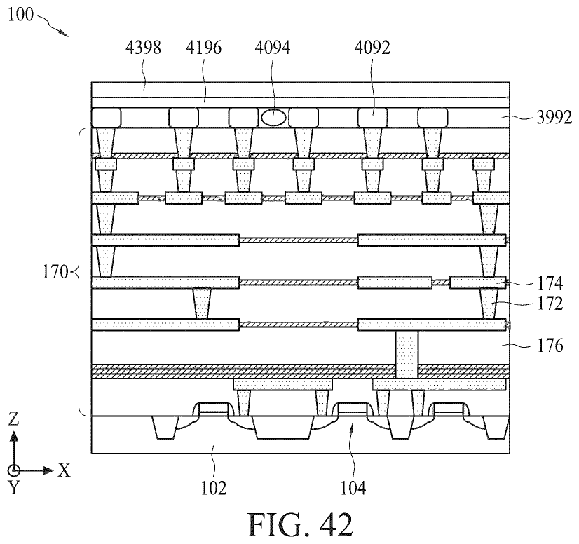

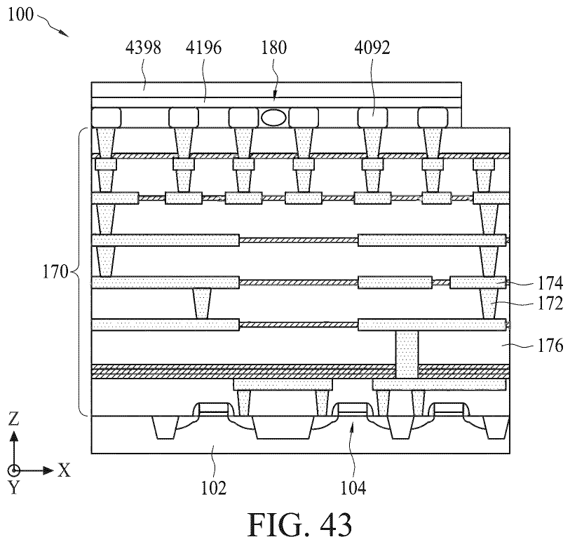

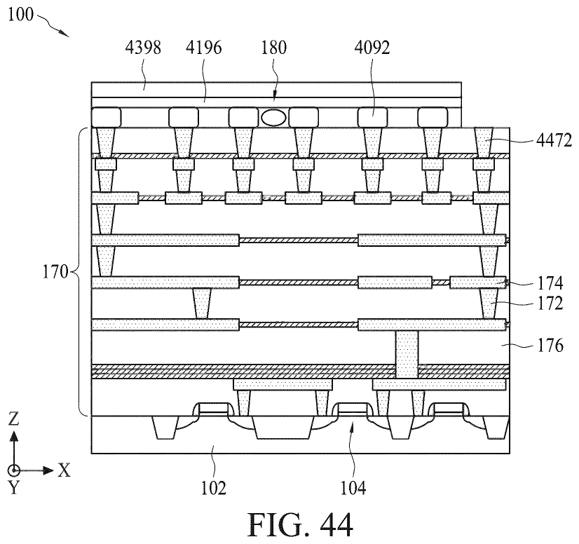

The formation of gate dielectric layer 4196 can be followed by the formation of gate structures. In some embodiments, as shown in FIG. 42, a conductive layer 4298 can be conformally deposited on gate dielectric layer 4196. In some embodiments, conductive layer 4298 can be deposited by CVD, ALD, PVD, or other suitable deposition methods. In some embodiments, conductive layer 4298 can include doped polysilicon, tungsten, tungsten silicide, titanium nitride, ruthenium, or other suitable conductive materials. In some embodiments, conductive layer 4298 can be patterned and defined to form gate structures 4398 of transistors 180, as shown in FIGS. 43 and 44. In some embodiments, as shown in FIG. 44, metal vias 4472 can be formed for connection between interconnect structures 170 and gate structures 4398.

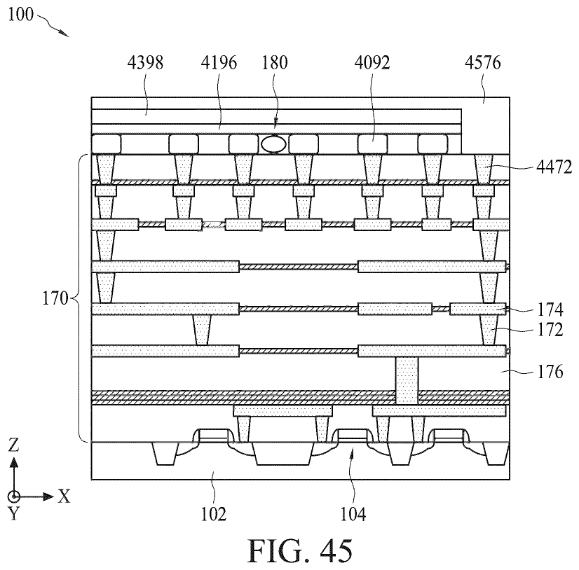

In some embodiments, the formation of gate structures 4398 can be followed by a formation of dielectric layer 4576, as shown in FIG. 45. In some embodiments, dielectric layer 4576 can be deposited CVD, ALD, or other suitable deposition methods. In some embodiments, dielectric layer 4576 can be conformally deposited on gate structures 4398 and interconnect structures 170 followed by a CMP process to planarize top surfaces. In some embodiments, dielectric layer 4576 and IDL 176 can include a same dielectric material.

Referring to FIG. 37, in operation 3740, a top metal layer is deposited on the interconnect structure and the transistor to form a transmission line structure connected to the transistor. For example, as shown in FIGS. 9-14 and 46, a top metal layer and metal vias 4672 can be deposited on interconnect structures 170 and transistors 180. The top metal layer can be patterned to form transmission line structures 128. Transmission line structures 128 can be connected to gate structures 4398 of transistors 180 and interconnect structures 170. In some embodiments, as shown in FIGS. 9 and 15, transmission line structures 128 can include grille structures 190 with pitch 190p. In some embodiments, as shown in FIGS. 21-24, transistors 180 can be formed between adjacent grille structures 190 and can be configured to electrically connect adjacent grille structures 190. In some embodiments, as shown in FIGS. 21-24, with different transistors 180 turned on, pitch 190p of grille structures 190 can be tuned to adjust the microwave index of transmission line structures 128.

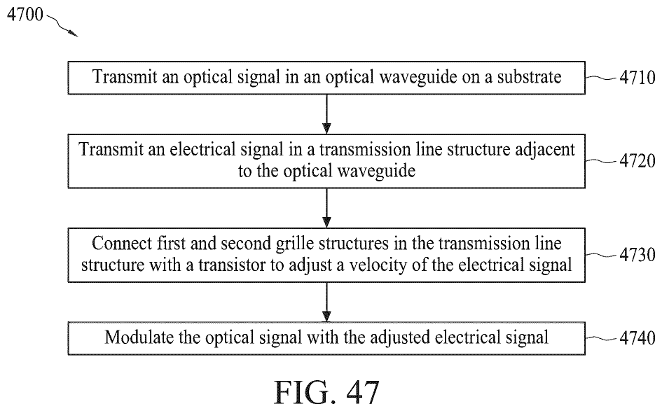

FIG. 47 is a flow diagram of a method 4700 for modulating an optical signal with an adjusted electrical signal, in accordance with some embodiments. Method 4700 may not be limited to semiconductor coupling device 100 and can be applicable to other coupling devices that would benefit from the adjusting the velocity of electrical signals with a transistor. Additional operations may be performed between various operations of method 4700 and may be omitted merely for clarity and ease of description. Additional operations can be provided before, during, and/or after method 4700; one or more of these additional operations are briefly described herein. Moreover, not all operations may be needed to perform the disclosure provided herein. Additionally, some of the operations may be performed simultaneously or in a different order than shown in FIG. 47. In some embodiments, one or more other operations may be performed in addition to or in place of the presently-described operations. For illustrative purposes, the operations illustrated in FIG. 47 will be described with reference to the example embodiments as illustrated in FIGS. 1A-1C, 2-15, and 21-24.

In referring to FIG. 47, method 4700 begins with operation 4710 and the process of transmitting an optical signal in an optical waveguide on a substrate. In some embodiments, as shown in FIGS. 1A-1C and 2-15, input optical signal 112 can be received by semiconductor coupling device 100 at optical input port 134. First and second optical waveguides 124 and 126 can transmit input optical signal 112 from optical splitter 130 to optical combiner 132.

Referring to FIG. 47, in operation 4720, an electrical signal is transmitted in a transmission line structure adjacent to the optical waveguide. For example, as shown in FIGS. 1A-1C and 2-15, input electrical signal 414 can be received by semiconductor coupling device 100 at electrical pads 150 and 152. Transmission line structures 128 can transmit input electrical signal 414 from electrical pads 150 to electrical pads 152. In some embodiments, transmission line structures 128 can be connected to other structures for the transmission of input electrical signal 414. In some embodiments, transmission line structures 128 can be disposed adjacent to first and second optical waveguides 124 and 126 to couple input electrical signal 414 to input optical signal 112.

Referring to FIG. 47, in operation 4730, first and second grille structures in the transmission line structure is connected to a transistor to adjust a velocity of the electrical signal. For example, as shown in FIGS. 21-24, controller 2100 can turn on transistors 180 at positions 1-5 to connect adjacent grille structures 190 of transmission line structures 128 and to adjust the velocity of the electrical signal in transmission line structures 128. In some embodiments, as shown in FIG. 21 with transistors 180 turned off at positions 1-5, grille structures 190 in transmission line structures 128 can have pitch 190p1. In some embodiments, as shown in FIG. 22, controller 1200 can turn on transistors 180 at positions 1, 3, and 5 while turning off transistors at positions 2 and 4. Grille structures 190 adjacent to transistors 180 at positions 1, 3, and 5 can be connected and grille structures 190 have increased pitch 190p2. Similarly, as shown in FIG. 23, controller 1200 can turn on transistors 180 at positions 1, 2, 3, and 5 while turning off transistors at position 4. Grille structures 190 adjacent to transistors 180 at positions 1, 2, 3, and 5 can be connected and grille structures 190 have further increased pitch 190p3. As described above, the increase of pitch 190p of grille structures 190 can decrease the phase shift junction capacitance of transmission line structures 128. The decrease of the phase shift junction capacitance of transmission line structures 128 can decrease the microwave index of transmission line structures 128. The decrease of the microwave index of transmission line structures 128 can increase the velocity of input electrical signal 414 in transmission line structures 128. In some embodiments, as shown in FIG. 24, one or more transistors 180 can be disposed at each of positions 1-5 to fine tune the microwave index of transmission line structures 128 and the velocity of input electrical signal 414 in transmission line structures 128.

Accordingly, connecting adjacent grille structures 190 with transistors 180 can increase pitch 190p, decrease the microwave index of transmission line structures 128, and thus increase the velocity of the electrical signals in transmission line structures 128. In some embodiments, controller 2100 can control transistors 180 to adjust the velocity of the electrical signals in transmission line structures 128 and to match the velocity of the optical signals in optical waveguides 124 and 126.

Referring to FIG. 47, in operation 4740, the optical signal is modulated with the adjusted electrical signal. For example, as shown in FIGS. 1-8, input optical signal 112 can be modulated with input electrical signal 414 with adjusted velocity matching the velocity of input optical signal 112. In some embodiments, as shown in FIG. 8, S21 3 dB bandwidth of semiconductor coupling device 100 increases with a decrease of the velocity difference between the optical signal and the electrical signal. In some embodiments, the velocity match of the electrical and optical signals can improve the coupling between the electrical signals and the optical signals, improve impedance matching of optical modulator 122, reduce the transmission loss of transmission line structures 128, and increase the signal-to-noise ratio and the S21 3 dB bandwidth of semiconductor coupling device 100.

Various embodiments in the present disclosure provide semiconductor coupling device 100 having transmission line structures 128 with a tunable microwave index. In some embodiments, semiconductor coupling device 100 can include first and second optical waveguides 124 and 126 on substrate 102 and transmission line structures 128 on substrate 102 and adjacent to optical waveguides 124 and 126. Optical waveguides 124 and 126 can be configured to transmit an optical signal (e.g., input optical signal 112) and transmission line structures 128 can be configured to transmit an electrical signal (e.g., input electrical signal 414). Transmission line structures 128 can include first and second grille structures 190. Semiconductor coupling device 100 can further include interconnect structures 170 connected to transmission line structures 128. Interconnect structures 170 can couple transmission line structures 128 to optical waveguides 124 and 126. Interconnect structures 170 can include transistors 180 configured to electrically connect adjacent first and second grille structures 190. In some embodiments, by electrically connecting adjacent first and second grille structures 190 with transistors 180, pitch 190p of grille structures 190 in transmission line structures 128 can be adjusted. As a result, the microwave index of transmission line structures 128 can be tuned to adjust the velocity of the electrical signal in transmission line structures 128. With tunable microwave index of transmission line structures 128, the velocity of the electrical signal can be matched to the velocity of the optical signal. Velocity match of the electrical and optical signals can improve the coupling between the electrical signal and the optical signal, improve impedance matching of optical modulator 122, reduce the transmission loss of transmission line structures 128, and increase the signal-to-noise ratio and the bandwidth of semiconductor coupling device 100.

In some embodiments, a coupling device includes an optical waveguide on a substrate and a transmission line structure on the substrate and adjacent to the optical waveguide. The transmission line structure includes a first grille structure and a second grille structure. The coupling device further includes an interconnect structure connected to the transmission line structure. The interconnect structures couples the transmission line structure to the optical waveguide and includes a transistor configured to electrically connect the first grille structure to the second grille structure.

In some embodiments, a system includes an optical waveguide configured to transmit an optical signal and a transmission line structure configured to transmit an electrical signal. The transmission line structure includes a first grille structure and a second grille structure. The system further includes an interconnect structure connected to the transmission line structure. The interconnect structure includes a transistor between the first grille structure and the second grille structure. The system further includes a controller configured to activate the transistor to electrically connect the first grille structure to the second grille structure.

In some embodiments, a method includes forming an optical waveguide on a substrate, forming an interconnect structure adjacent to the optical waveguide, forming a transistor on the interconnect structure, and depositing a metal layer on the interconnect structure and the transistor to form a transmission line structure. The transmission line structure includes a first grille structure and a second grille structure. The transistor is configured to connect the first grille structure to the second grille structure.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

1. A device, comprising:
an optical waveguide on a substrate;
a transmission line structure on the substrate and adjacent to the optical waveguide, wherein the transmission line structure comprises a first grille structure and a second grille structure; and
an interconnect structure coupling the transmission line structure to the optical waveguide, wherein the interconnect structure comprises a transistor configured to electrically connect the first grille structure to the second grille structure.

2. The device of claim 1, further comprising a third grille structure and a second transistor, wherein the second transistor is configured to connect the second grille structure to the third grille structure.

3. The device of claim 2, further comprising a fourth grille structure and a third transistor, wherein the third transistor is configured to connect the third grille structure to the fourth grille structure.

4. The device of claim 1, wherein the first and second grille structures are connected to the interconnect structure.

5. The device of claim 1, further comprising a second transistor parallel to the transistor and configured to connect the first grille structure to the second grille structure, wherein gate terminals of the transistor and the second transistor are connected to a same metal layer.

6. The device of claim 1, further comprising a second transistor parallel to the transistor and configured to connect the first grille structure to the second grille structure, wherein gate terminals of the transistor and the second transistor are connected to different metal layers.

7. The device of claim 1, wherein the transistor is a thin film transistor comprising a gate terminal connected to a first metal layer and a source/drain terminal connected to a second metal layer different from the first metal layer.

8. The device of claim 1, wherein the transistor is in a top metal layer or a middle metal layer of the interconnect structure.

9. The device of claim 1, wherein a pitch of the transmission line structures is adjustable through the transistor.

10. The device of claim 1, further comprising a metal heater structure adjacent to the optical waveguide.

11. A method, comprising:
transmitting an optical signal in an optical waveguide on a substrate;
transmitting an electrical signal in a transmission line structure adjacent to the optical waveguide, wherein the transmission line structure comprises a first grille structure and a second grille structure;
connecting the first and second grille structures with a transistor to adjust a velocity of the electrical signal; and
modulating the optical signal with the adjusted electrical signal.

12. The method of claim 11, further comprising connecting the first and second grille structures with an additional transistor to tune the velocity of the electrical signal.

13. The method of claim 11, wherein the transmission line structure further comprises a third grille structure and a fourth grille structure, and wherein the method further comprises connecting the third and fourth grille structure with an additional transistor to further adjust the velocity of the electrical signal.

14. The method of claim 11, further comprising adjusting a pitch of the transmission line structure with the transistor.

15. The method of claim 11, wherein connecting the first and second grille structures with the transistor comprises:
connecting a first source/drain terminal of the transistor to the first grille structure;
connecting a second source/drain terminal of the transistor to the second grille structure; and
activating a gate terminal of the transistor.

16. A method, comprising:
forming an interconnect structure adjacent to an optical waveguide;
forming a transistor on the interconnect structure; and
depositing a metal layer on the interconnect structure and the transistor to form a transmission line structure, wherein:
the transmission line structure comprises a first grille structure and a second grille structure; and
the transistor is configured to connect the first grille structure to the second grille structure.

17. The method of claim 16, wherein forming the optical waveguide comprises depositing an electro-optic material on the substrate.

18. The method of claim 16, wherein forming the transistor comprises:
forming a semiconductor layer on the interconnect structure;
implanting the semiconductor layer to form a channel region and source/drain regions of the transistor, wherein the source/drain regions are connected to a first metal layer of the interconnect structure;
depositing a gate dielectric layer on the semiconductor layer;
forming a gate structure on the gate dielectric layer; and
connecting the gate structure to the transmission line structure.

19. The method of claim 18, wherein forming the semiconductor layer comprises depositing a semiconductor material on the interconnect structure, and wherein the semiconductor material comprises amorphous silicon, indium gallium zinc oxide, indium gallium oxide, gallium zinc oxide, or indium zinc oxide.

20. The method of claim 18, wherein forming the gate structure comprises:
depositing a layer of conductive material on the gate dielectric layer, wherein the conductive material comprises polysilicon, titanium nitride, tungsten, tungsten silicide, or ruthenium; and
patterning the layer of conductive material to form the gate structure.
